(19) United States
(12) Patent Application Publication
(10) Pub. No.: US 2018/0219509 A1
(43) Pub. Date: Aug. 2, 2018

(54) EASY TO INSTALL FLEXIBLE PHOTOVOLTAIC MODULES

(71) Applicants: Robert Martinson, Palo Alto, CA (US); Cormac Wicklow, San Jose, CA (US); Jason Cheng, Cupertino, CA (US); Arthur Cheung, San Jose, CA (US); Heinrich von Bunau, San Jose, CA (US); Darin S. Birtwhistle, Santa Clara, CA (US); Hyung Paek, Burlingame, CA (US); Robert McClymond, San Jose, CA (US)

(72) Inventors: Robert Martinson, Palo Alto, CA (US); Cormac Wicklow, San Jose, CA (US); Jason Cheng, Cupertino, CA (US); Arthur Cheung, San Jose, CA (US); Heinrich von Bunau, San Jose, CA (US); Darin S. Birtwhistle, Santa Clara, CA (US); Hyung Paek, Burlingame, CA (US); Robert McClymond, San Jose, CA (US)

(21) Appl. No.: 15/422,355

(22) Filed: Feb. 1, 2017

(51) Int. Cl. H02S 30/20; H02S 40/32; H02S 40/36; H02S 40/34; H02S 20/23

(52) U.S. Cl. CPC H02S 30/20; H02S 40/32; H02S 20/23; H02S 40/34; H02S 40/36

(57) ABSTRACT

Disclosed are apparatuses and methods for an apparatus that has a flexible mounting substrate, one or more flexible photovoltaic modules attached to the flexible mounting substrate, one or more inverters attached to the flexible mounting substrate and electrically connected to the one or more flexible photovoltaic modules, a flexible electrical conduit electrically connected to the one or more inverters and to the one or more flexible photovoltaic modules, a plurality of mounting features, and a plurality of flexible connectors that extend between the flexible mounting substrate and one corresponding mounting feature, that is configured to be positioned above a structure and secured to the structure without penetrating roofing of the structure.

### BACKGROUND

Photovoltaic technology is being rapidly adopted to generate electricity from solar energy, both for local use and for supplying power to electrical grids. Photovoltaic systems may be implemented on structures, such as buildings and houses. Photovoltaic cells are the basic units of such systems. One or more photovoltaic cells are typically arranged into a photovoltaic module, which may be then used to form a photovoltaic array.

### SUMMARY

In one embodiment, an apparatus may be provided. The apparatus may include a flexible mounting substrate, one or more flexible photovoltaic modules, each of the flexible photovoltaic modules may be attached to the flexible mounting substrate; one or more inverters, the one or more inverters may be electrically connected to the one or more flexible photovoltaic modules, and each of the inverters may be connected to the flexible mounting substrate; a plurality of mounting features configured to be attached to a structure; a plurality of flexible connectors, one flexible connecter may extend between the flexible mounting substrate and one corresponding mounting feature and each flexible connector may be attached to the flexible mounting substrate and attached to a corresponding mounting feature such that the plurality of mounting features is attached to the flexible mounting substrate by the plurality of flexible connectors; and a flexible electrical conduit. A first end of the flexible electrical conduit may be electrically connected to the one or more inverters and to the one or more flexible photovoltaic modules, a portion of the electrical conduit may extend along and be attached to one flexible connector, and each of the mounting features may be configured to secure the flexible mounting substrate above the structure without penetrating roofing of the structure.

In some embodiments, there may be two or more flexible photovoltaic modules, there may be two or more inverters, each flexible photovoltaic module may be electrically connected to one corresponding inverter, and the two or more inverters may be electrically connected in parallel.

In some embodiments, the apparatus may further include an electrical junction box that is attached to the flexible mounting substrate, the one or more inverters may be electrically connected to the electrical junction box, and the first end of the flexible electrical conduit may be electrically connected to the electrical junction box such that the flexible electrical conduit is electrically connected to the one or more inverters at the electrical junction box.

In some embodiments, a second end of the flexible electrical conduit may be configured to terminate at an electrical connection point of an external electrical circuit.

In some embodiments, the apparatus may further include an alternating current (“AC”) disconnect and a second end of the flexible electrical conduit may terminate at the AC disconnect.

In some embodiments, the flexible photovoltaic modules may be attached to the flexible mounting substrate by an adhesive.

In some embodiments, the apparatus may further include a second flexible mounting substrate; one or more second flexible photovoltaic modules, each of the second flexible photovoltaic modules may be attached to the second flexible mounting substrate; one or more second inverters, the one or more second inverters may be electrically connected to the one or more second flexible photovoltaic modules, and each of the second inverters may be attached to the second flexible mounting substrate; a plurality of second mounting features configured to be attached to the structure; and a plurality of second flexible connectors, one second flexible connecter may extend between the second flexible mounting substrate and one corresponding second mounting feature and each second flexible connector may be attached to the second flexible mounting substrate and attached to a corresponding second mounting feature such that the plurality of second mounting features is attached to the second flexible mounting substrate by the plurality of second flexible connectors. The one or more second inverters may be electrically connected to the one or more inverters and electrically connected to the first end of the flexible electrical conduit and each of the second mounting features may be configured to secure the second flexible mounting substrate above the structure without penetrating the roofing of the structure.

In some embodiments, each flexible photovoltaic module may have a power-to-weight performance ratio greater than about 55 Watts per kilogram.

In some embodiments, each flexible photovoltaic module may have a photovoltaic stack with a thickness of about 2 microns or less that is positioned on a substrate with a thickness of about 50 microns or less.

In some embodiments, the flexible mounting substrate may be comprised of high-density polyethylene.

In some embodiments, the apparatus may further include a cover that is attached to the flexible mounting substrate and that covers the one or more inverters such that the one or more inverters are interposed and at least partially enclosed by the flexible mounting substrate and the cover.

In some embodiments, the apparatus may further include one or more inverter frames attached to the flexible mounting substrate, each inverter may be attached to one corresponding inverter frame such that each inverter is not in direct contact with the flexible mounting substrate and is offset from the mounting substrate by a first offset distance.

In some embodiments, the apparatus may further include a ridge protector that is configured to be positioned on a ridge of the roof and interposed between a flexible connector and the ridge of the roof such that there is no contact between the ridge and the flexible connector.

In one embodiment, a method may be provided. The method may include positioning an apparatus above a structure, the apparatus may include a flexible mounting substrate, one or more flexible photovoltaic modules attached to the flexible mounting substrate, and one or more inverters attached to the flexible mounting substrate; attaching a plurality of mounting features to the structure without penetrating a roofing of the structure; connecting, using a plurality of flexible connectors, each mounting feature to the flexible mounting substrate such that the flexible mounting substrate is secured above the structure, one flexible connecter may extend between the flexible mounting substrate and one corresponding mounting feature; and electrically connecting, using a flexible electrical conduit, the one or more flexible photovoltaic modules to an electrical connection point of an external electrical circuit.

In some embodiments, the method may further include electrically connecting each inverter to one corresponding flexible photovoltaic module, and electrically connecting the flexible electrical conduit to the one or more inverters.

In some embodiments, the method may further include electrically connecting each inverter to an electrical junction box. Each inverter may be electrically connected to one corresponding photovoltaic module and electrically connecting the one or more flexible photovoltaic modules to the electrical connection point of the external electrical circuit further includes electrically connecting a first end of the flexible electrical conduit to the junction box and electrically connecting a second end of the flexible electrical conduit to the electrical connection point of the external electrical circuit.

In some such embodiments, electrically connecting the one or more flexible photovoltaic modules to the electrical connection point of the external electrical circuit further includes electrically connecting the second end of the flexible electrical conduit to an alternating current (“AC”) disconnect that is electrically connected to the external electrical circuit.

In some embodiments, the method may further include attaching the AC disconnect to the structure.

In some embodiments, connecting each mounting feature to the flexible mounting substrate further comprises connecting a first end of each flexible connector to the flexible mounting substrate and a second end of each flexible connector to a corresponding mounting feature.

In some embodiments, the method may further include connecting a portion of the flexible electrical conduit to one flexible connector.

### BRIEF DESCRIPTION OF THE DRAWINGS

FIG. 1 depicts an isometric view of an example apparatus.

FIG. 2 depicts an off-angle, exploded view of aspects of the example apparatus of FIG. 1.

FIG. 3 depicts cross-sectional and detail views of an example flexible photovoltaic cell.

FIG. 4 depicts an isometric view of an inverter frame.

FIG. 5 depicts a cross-sectional side view of an inverter frame attached to an inverter and a flexible mounting substrate.

FIG. 6 depicts a plan view of some of the aspects of the apparatus of FIG. 1.

FIG. 7 depicts a detail view of a portion of the apparatus of FIG. 6.

FIG. 8 depicts an example electrical circuit of the apparatus.

FIG. 9 depicts two isometric views of aspects of the apparatus of FIG. 1 with a cover.

FIG. 10 depicts a partial cross-sectional view of the apparatus of FIG. 9.

FIG. 11 depicts an off-angle view of the example mounting feature of FIG. 1.

FIG. 12 depicts the example mounting feature of FIG. 11 secured to a part of a structure.

FIG. 13 depicts three other example mounting features.

FIGS. 14 and 15 depict off-angle views of the three other example mounting features of FIG. 13 attached to a structure.

FIGS. 16 and 17 depict two off-angle views of additional example mounting features attached to another example structure.

FIG. 18 depicts an isometric view of the example apparatus of FIG. 1 secured to an example house.

FIG. 19 depicts a detail view of a part of FIG. 18.

FIG. 20 depicts a detail, isometric view of a ridge of an example house with an example ridge protector and a flexible connector.

FIG. 21 depicts another example embodiment of the apparatus.

FIG. 22 depicts a flowchart of an example technique.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific implementations, it will be understood that these implementations are not intended to be limiting.

There are many concepts and implementations described and illustrated herein. While certain features, attributes and advantages of the implementations discussed herein have been described and illustrated, it should be understood that many others, as well as different and/or similar implementations, features, attributes and advantages of the present inventions, are apparent from the description and illustrations. As such, the below implementations are merely some possible examples of the present disclosure. They are not intended to be exhaustive or to limit the disclosure to the precise forms, techniques, materials and/or configurations disclosed. Many modifications and variations are possible in light of this disclosure. It is to be understood that other implementations may be utilized and operational changes may be made without departing from the scope of the present disclosure. As such, the scope of the disclosure is not limited solely to the description below because the description of the above implementations has been presented for the purposes of illustration and description.

Importantly, the present disclosure is neither limited to any single aspect nor implementation, nor to any single combination and/or permutation of such aspects and/or implementations. Moreover, each of the aspects of the present disclosure, and/or implementations thereof, may be employed alone or in combination with one or more of the other aspects and/or implementations thereof. For the sake of brevity, many of those permutations and combinations will not be discussed and/or illustrated separately herein.

The installation of photovoltaic cells onto buildings, structures, and homes is becoming more and more popular. However, there are many drawbacks to conventionally installed photovoltaic modules, such as high cost and difficulty of installation. For example, many photovoltaic modules are heavy, such as about 2 to 3 pounds per square foot, and their installation may require specialized lifting and mounting equipment, specialized knowledge about photovoltaic modules, engineering, construction, roof structures, and/or electric systems, and specialized trades or skills to adequately perform such installation. Additionally, conventional photovoltaic modules have weights that require a structure sufficient to uphold that weight and have rigidity that also requires a sub structure to define a foundation for installing the panels. Some conventional photovoltaic panels must also be installed one photovoltaic panel at a time which includes securing each individual photovoltaic panel to the structure and then electrically connect it, after which the next photovoltaic panel can be installed. The sub structures of some such conventional photovoltaic modules and photovoltaic panels require substantial materials and design to accomplish the goal of placing the modules on the rooftop and require penetrating the roofing material, thereby compromising the roofing material's water-tight covering. Glass photovoltaic panels are also fragile and subject to breakage during installation and in the case of large hail.

Once a typical photovoltaic panel or module is installed in an array, it is difficult to remove such panel or module for servicing of the photovoltaic system and the roof, such as to remove debris or other materials trapped between the typical photovoltaic system and the roof. Additionally, the age of the existing roof of the structure affects the ability to install current photovoltaic modules. Older roofs may not be able to support typical photovoltaic modules and the roof replacement is cost prohibitive to many consumers.

Moreover, most typical photovoltaic cells permanently modify the structure and/or systems of the structure to which they are attached. For example, many photovoltaic cells are typically installed or affixed to a roof of a structure through the use of rigid frames, mounts, and/or brackets that are attached directly to the roof itself and/or to the structure underneath the roof. As used herein, the term “roof” is a broad term that means the structure forming the upper covering of a building or similar structure and which encompasses the support structure of the roof, such as decking, purlin, joists, rafters, ridge boards, eaves, soffits, fascia boards, gables, barge boards, for example; the term roof also includes the roofing of the roof, which means the external upper covering of the roof and includes the material for constructing a building's roof, such as tar, tar paper, shingles, slate, and tin, for instance. Roofing also includes the material of the roof which forms a waterproof, or water-resistant, barrier between the inside of the structure and the external environment above the roof.

Such conventional installation of photovoltaic cells usually involves puncturing the roofing, including the waterproofing of the roofing, in numerous locations in order to access the underlying structure so that fasteners, such as screws or bolts, may be affixed into or onto that structure. For example, a photovoltaic mounting frame may be attached onto a roof of a house by mounting brackets that are secured to the house by screws that run through the roof, including through the roofing, and into the underlying joists, thereby penetrating and puncturing the waterproof roofing of the roof. Although efforts may be made to seal the punctures into the waterproof roofing, such punctures may nevertheless cause permanent modification to the roofing and potentially lead to leaks in the roof and roofing which may damage and degrade the structure underneath the punctured roof.

Accordingly, embodiments of the present disclosure relate to, among other things, methods and apparatuses for mounting, installing, and/or securing flexible photovoltaic modules to, on, adjacent to, and/or over a structure without permanently modifying the roofing of the structure and that are relatively easy to install on the structure. For example, a consumer may be able to install this apparatus to a home in two hours or less. An example installation process may involve unrolling a flexible mounting substrate and attached components on a roof, attaching mounting features to the structure without penetrating the roofing, connecting the mounting features to the flexible mounting substrate, and making the appropriate electrical connections. For example, the mounting features may be attached at the perimeter of the roof, such as at the eaves, where a structural member of the structure to which the mounting features are being attached may be exposed, easy to see, and easy to access. Furthermore, the apparatus disclosed herein may be installed on a structure without locating the rafters under the main sections of the roof. Electrical connections may be made with the use of easy-to-use electrical connectors, such that there is generally no need to cut wires, connect bare wires, or ensure the integrity of electrical enclosures. In the event that the wattage capacity of the apparatus is to be increased, additional units (as described below) may be installed next to the existing system and electrically connected with a single electrical connector.

In some example embodiments, the apparatus may include a flexible mounting substrate and flexible photovoltaic modules attached to the flexible mounting substrate. The apparatus may be configured to be placed on or above the roof (e.g., above the roofing) of the structure and configured to be secured to the structure with a plurality of mounting features that are configured to secure the flexible mounting substrate above the structure, e.g., above the roof, without penetrating the roofing. The photovoltaic cells may be electrically connected to each other, to one or more inverters, and to an external electrical circuit, such as the general power grid or the electric grid of the structure.

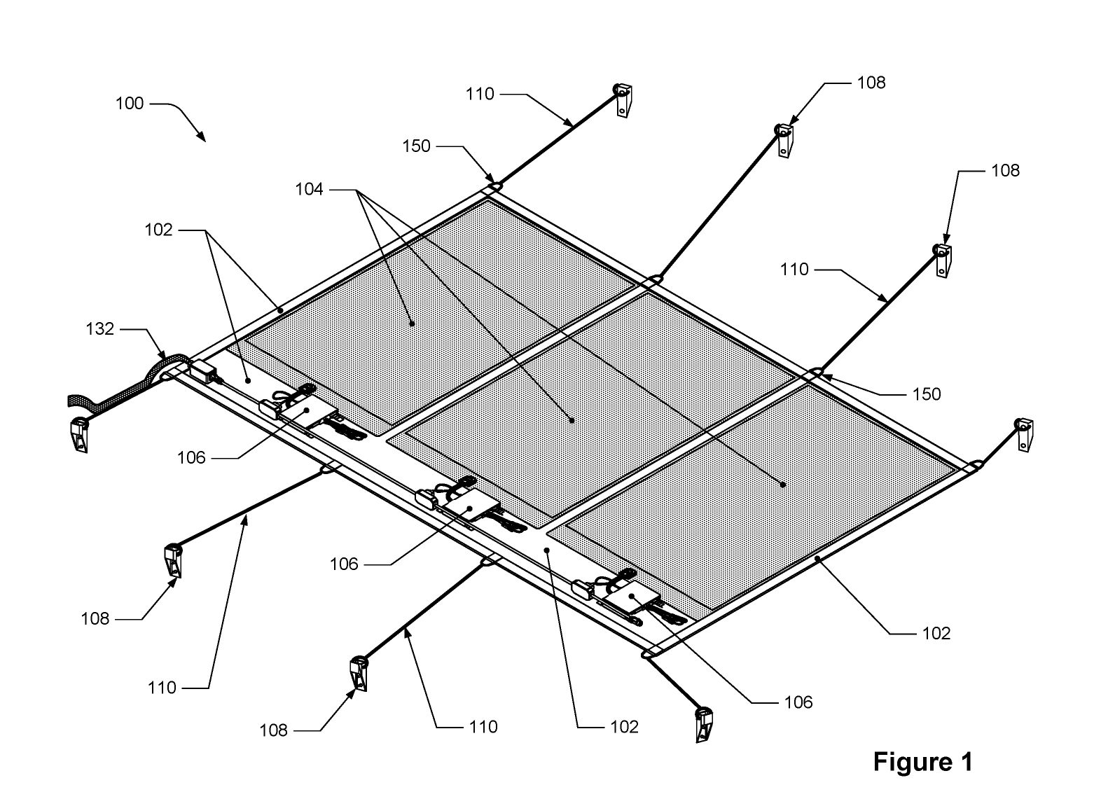

FIG. 1 depicts an isometric view of an example apparatus. The apparatus 100 of FIG. 1 includes a flexible mounting substrate 102, three flexible photovoltaic modules 104 (highlighted with shading), three inverters 106, a plurality of mounting features 108 (only some of which are labeled), and a plurality of flexible connectors 110 (only some of which are labeled). The flexible mounting substrate 102 may serve as the mounting base for numerous components of the apparatus and these components may be attached to the flexible mounting substrate 102 in a variety of ways.

For instance, each of the flexible photovoltaic modules 104 is individually attached to the flexible mounting substrate 102. In some embodiments, this attachment may be made using an adhesive, such as a pressure sensitive adhesive, a temperature sensitive adhesive, or a pressure and temperature sensitive adhesive. The flexible photovoltaic modules 104 are attached to the flexible mounting substrate 102 such that the flexible mounting substrate 102 does not obscure, or does not substantially obscure (e.g., obscure less than about 10%), the photovoltaic layer of each flexible photovoltaic module 104 that generates a voltage when exposed to light. For instance, in some embodiments the flexible photovoltaic modules may be placed underneath the flexible mounting substrate and in these embodiments, it is contemplated that the flexible mounting substrate does not obscure the photovoltaic layer of the flexible photovoltaic modules.

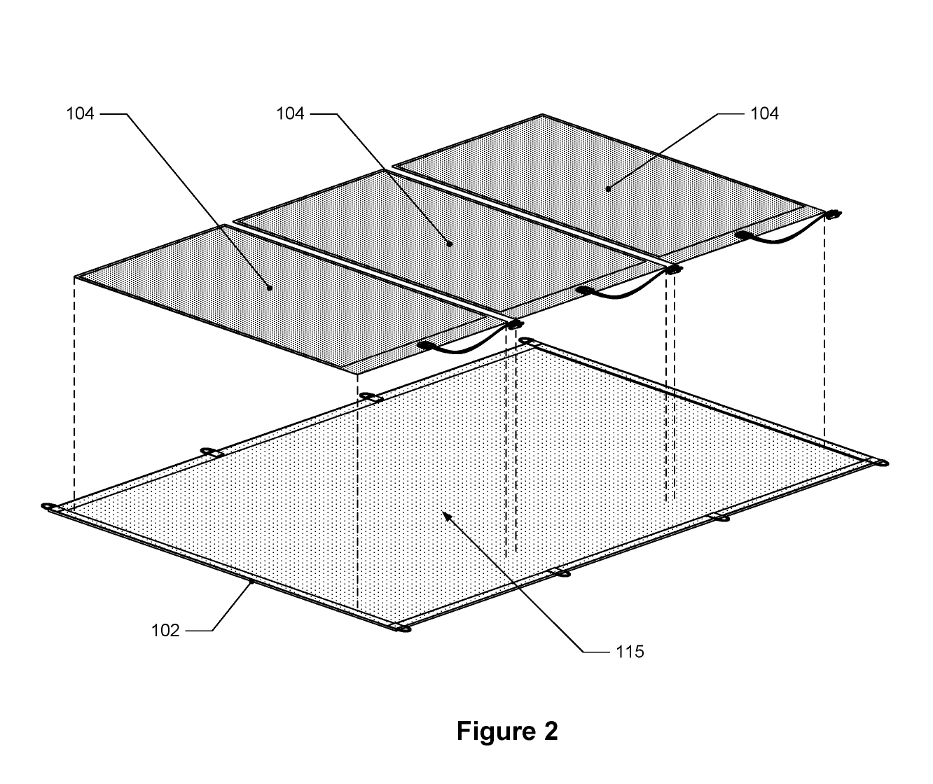

In some embodiments, like that depicted in FIG. 1, the flexible photovoltaic modules 104 are placed on top of and attached to the flexible mounting substrate 102 such that the photovoltaic layer of each flexible photovoltaic module 104 is not obscured by the flexible mounting substrate 102. FIG. 2 depicts an off-angle, exploded view of aspects of the example apparatus of FIG. 1; only the flexible photovoltaic modules 104 and the flexible mounting substrate 102 are depicted in FIG. 2. As can be seen with better clarity, the flexible mounting substrate 102 includes a top side 115 (highlighted with light shading) and the flexible photovoltaic modules 104 are attached to the top side 115 of the flexible mounting substrate 102. It should be noted that the terms attached and connected, when discussing physical, not electrical, connections or attachments are used synonymously throughout. In some embodiments, at least a portion of a backside of each flexible photovoltaic module 104 may be in direct contact with the flexible mounting substrate 102 while in some other embodiments, the backside of each flexible photovoltaic module 104 may not be in direct contact with the flexible mounting substrate, but may instead be in direct contact with an adhesive layer which is interposed between and in direct contact with both the flexible mounting substrate 102 and the backside of the flexible photovoltaic module 104.

The flexible photovoltaic modules discussed herein may be any photovoltaic modules that are flexible. The flexible photovoltaic module may include one or more flexible photovoltaic cells provided in a sealed space between two sealing sheets, one of which may form the back side of the flexible photovoltaic module. In certain embodiments, the flexible photovoltaic modules include thin film photovoltaic cells. However, any type of cell that can be implemented in a flexible photovoltaic module may be used.

Examples of photovoltaic cells include copper indium gallium selenide (CIGS) cells, cadmium-telluride (Cd—Te) cells, amorphous silicon (a-Si) cells, microcrystalline silicon (Si) cells, crystalline silicon (c-Si) cells, gallium arsenide (GaAs) multi-junction cells, light adsorbing dye cells, organic polymer cells, and other types of photovoltaic cells. Some photovoltaic cells have a thin film stack with multiple layers, such as a substrate, a bottom electrode, an absorber (such as CIGS or Si cells), a buffer layer, and a top electrode. The substrate may be a flexible conductive substrate, such as stainless steel foil, titanium foil, copper foil, aluminum foil, or beryllium foil. As discussed above, a photovoltaic cell has a photovoltaic layer, e.g., an absorber layer, that generates a voltage when exposed to light. The absorber layer may be positioned adjacent to an electrode layer, for example, a thin flexible layer of molybdenum, niobium, copper, and/or silver. Another example includes a conductive oxide or metallic deposition over a polymer film, such as polyimide. In certain embodiments, a substrate has a thickness of between about 1 mils (30 micron) and 10 mils (250 micron), e.g., about 2 mils (50 micron) typically, with other thicknesses also in the scope of the embodiments described herein. The photovoltaic cell also includes a top flexible conductive layer, e.g., the top electrode. This layer typically includes one or more transparent conductive oxides (TCO), such as zinc oxide, aluminum doped zinc oxide (AZO), indium tin oxide (ITO), and gallium doped zinc oxide. A typical thickness of the top electrode layer is between about 100 nanometers and 1,000 nanometers, e.g., between about 200 nanometers and 800 nanometers.

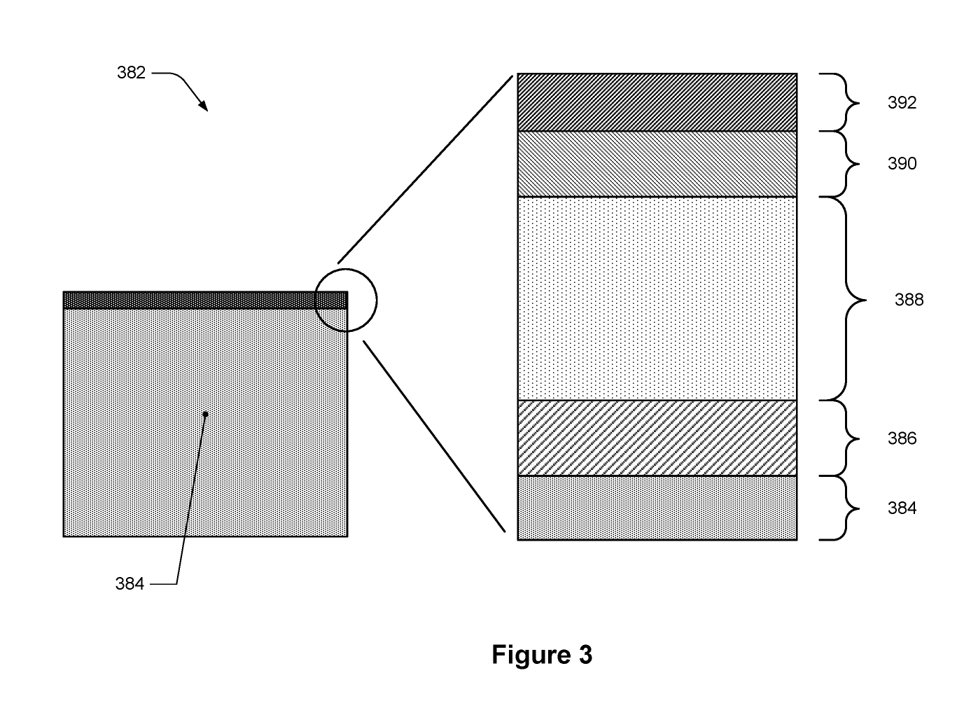

FIG. 3 depicts cross-sectional and detail views of an example flexible photovoltaic cell. As can be seen, the example flexible photovoltaic cell 382 includes a substrate 384, that may be about 50 microns thick, and additional layers placed on top of the substrate 384, which include a bottom electrode 386, an absorber layer 388, such as a CIGS layer, a buffer layer 390, and a top electrode 392. The a bottom electrode 386 can be seen interposed between and in direct contact with the absorber layer 388 and the substrate 384, the absorber layer 388 is interposed between and in direct contact with the bottom electrode 386 and the buffer layer 390, and the buffer layer 390 is interposed between and in direct contact with the top electrode 392 and the absorber layer 388. The thickness of the bottom electrode 386, the absorber layer 388, the buffer layer 390, and the top electrode 392 may be about 2.5 microns thick.

The photovoltaic cells may be interconnected using one or more wire networks. A wire network may extend over a front side of one cell as well as over a back side of another, adjacent cell to interconnect these two cells in series. Electrical leads may be electrically connected to conductive elements. A flexible photovoltaic module may include any number of photovoltaic cells. Moreover, the photovoltaic cells may be arranged and interconnected in any appropriate fashion using any appropriate electrical connector in addition to or instead of wire networks and bus bars.

The flexible sealing sheets of the photovoltaic module may include flexible materials such as polyethylene, polyethylene terephthalate (PET), polypropylene, polybutylene, polybutylene terephthalate (PBT), polyphenylene oxide (PPO), polyphenylene sulfide (PPS) polystyrene, polycarbonates (PC), ethylene-vinyl acetate (EVA), fluoropolymers (e.g., polyvinyl fluoride (PVF), polyvinylidene fluoride (PVDF), ethylene-terafluoethylene (ETFE), fluorinated ethylene-propylene (FEP), perfluoroalkoxy (PFA) and polychlorotrifluoroethane (PCTFE)), acrylics (e.g., poly(methyl methacrylate)), silicones (e.g., silicone polyesters), and/or PVC, as well as multilayer laminates and co-extrusions of these materials. Example thicknesses of a sealing sheet may be between about 5 mils and 100 mils or, for example, between about 10 mils and 50 mils. In certain embodiments, a sealing sheet includes a metallized layer to improve its water permeability characteristics. For example, a metal foil may be positioned in between two insulating layers to form a composite back side sealing sheet. In some embodiments, each flexible photovoltaic module may have a photovoltaic stack with a thickness of about 2 microns or less that is positioned on a substrate with a thickness of about 50 microns or less

In certain embodiments, a flexible photovoltaic module may have an encapsulant layer positioned between the front side sealing sheet and the photovoltaic cells. Another encapsulant layer may be provided between the back side sealing sheet and the photovoltaic cells. Examples of encapsulant layer materials include non-olefin TPO, such as polyethylene polypropylene, polybutylene, polyethylene terephthalate, polybutylene terephthalate, polystyrene, polycarbonates, fluoropolymers, acrylics, ionomers, silicones, and combinations thereof. In some embodiments, an encapsulant includes a linear low density polymer such as a linear low density polyethylene.

The photovoltaic module may also include one or more module connectors which may include one or more conductive elements. A total number of conductive elements in the module connector may vary and in certain embodiments, a module connector includes two conductive elements and in such embodiments, both of these conductive elements may be connected to the photovoltaic cells of the module. In some other embodiments, one of these elements may be connected to the photovoltaic cells of the module, while another one may be connected a return line.

The flexible photovoltaic modules of the present disclosure have a high power to weight performance ratio. For instance, some flexible photovoltaic modules of the present disclosure may have a power to weight performance ratio of up to about 62 Watts per kilogram; some other flexible photovoltaic modules of the present disclosure may have a power to weight performance ratio of up to about 78 Watts per kilogram. In contrast, for example, some photovoltaic modules in the marketplace have a lower power to weight performance ratio, such as up to about 12 Watts per kilogram or up to about 16 Watts per kilogram. Accordingly, flexible photovoltaic modules of the present disclosure are contemplated to have a power to weight performance ratio of more than about 60 Watts per kilogram. Additionally, the flexible photovoltaic modules of the present disclosure may have a weight of about 11 pounds. The power to weight performance ratio of the flexible photovoltaic modules disclosed herein may contribute to, at least in part, the feasibility, simplicity, and ease of installation of the apparatus.

Flexible photovoltaic modules encompassed by the present disclosure are also described in U.S. patent application Ser. Nos. 14/252,321 and 14/252,282, which are hereby incorporated by reference in their entireties.

The term “flexible” with regard to a flexible photovoltaic module means that the flexible photovoltaic module is capable of being flexed to make a U-shape by an average person using moderate force without significant damage to the cells, for instance being elastically deformed without causing damage to the photovoltaic module and plastically deforming the flexible photovoltaic module. Additionally, the flexible mounting substrate with the attached flexible photovoltaic modules is capable of being rolled up and placed in packaging, e.g., a box, for transportation.

Returning back to FIG. 1, each of the inverters 106 may also be connected to the flexible mounting substrate 102. In some embodiments, this connection may be made by an adhesive between each inverter 106 and the flexible mounting substrate 102; in some such embodiments, at least of portion of each inverter 106 may be in direct contact with the flexible mounting substrate 102 while in some other embodiments, no portion of the inverter 106 may be in direct contact with the flexible mounting substrate 102 and an adhesive layer may be interposed between the inverter 106 and the flexible mounting substrate 102. In some other embodiments, the inverter 106 may be connected to the flexible mounting substrate 102 by an inverter frame. In some such embodiments, the inverter 106 may be connected directly to the inverter frame and thereby offset from the flexible mounting substrate 102 by a first offset distance.

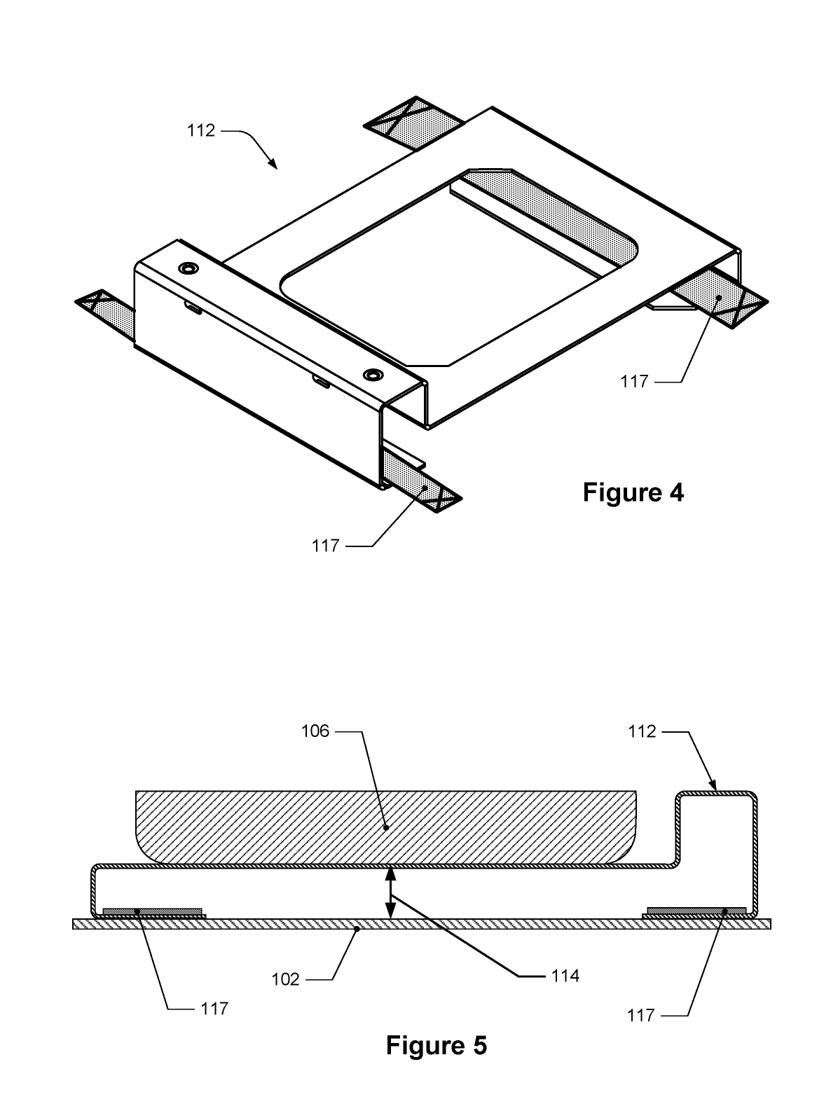

FIG. 4 depicts an isometric view of an inverter frame and FIG. 5 depicts a cross-sectional side view of an inverter frame connected to an inverter and a flexible mounting substrate. As can be seen in FIGS. 4 and 5, the inverter frame 112 is configured to connect with and support an inverter 106 such that the inverter 106 is not in direct contact, e.g., not touching, the flexible mounting substrate 102 and the inverter is offset from the flexible mounting substrate 102 by a first offset distance 114. Such first offset distance may be a minimum clearance distance required by the inverter for air flow, heat, or other parameters, for example about 0 inches to about 1 inch, such as ¾ of an inch. The inverter frame 112 may be connected to the flexible mounting substrate 102 by means such as adhesives, screws, bolts, and/or straps. In one example, a strap of polymer or a polymer/acrylic blend webbing is used which is attached to the flexible mounting substrate by sewing the polymer webbing to the flexible mounting substrate, such as polymer webbing 117 depicted in FIGS. 4 and 5. As can be seen, the polymer webbing 117 may be arranged in strips and each end of each strip may be sewn to the flexible mounting substrate 102 as indicated by the “X” on each polymer webbing 117 in FIG. 4. Such configuration may create loops or slots in which aspects of the inverter frame 112 may be inserted and which therefore enables the inverter frame to be attached to the flexible mounting substrate 102; the polymer webbing 117 may extend over parts of the inverter frame 112 such that the inverter frame 112 may be attached to the flexible mounting substrate 102. The inverter 106 may also be connected to the inverter frame 112 by means, such as bolts, screws, adhesives, or a plate that extends over the inverter 106 and secures the inverter 106 to the inverter frame 112. The inverter 106 in FIG. 5 is therefore connected to the flexible mounting substrate 102 because the inverter 106 is connected to the inverter frame 112 which is connected to the flexible mounting substrate 102. In some embodiments, the connection between the inverter frame and flexible mounting substrate, and between the inverter frame and the inverter, may not be a permanent connection such that the inverter frame and/or inverter may be removed in a nondestructive way.

The inverters 106 may have any suitable electronic arrangement that provides the desired electrical output characteristics to be useful for the apparatus. For example, the inverters may be a microinverter which may be designed for use with photovoltaic modules. For example, a microinverter may have a maximum DC input voltage of about 62 V and a peak output power of about 250 W. Additionally, some inverters 106 may have an output that may be tied in parallel with a Utility Grid and meet the requirements of being Grid Tied as determined by the Utility. In some embodiments, the inverters 106 may be a DC Regulator or a Charge Controller which may be configured to charge a battery.

The apparatus of FIG. 1 may also have electrical connections between some of its components to transfer the energy generated by the flexible photovoltaic modules to an external electrical circuit. In the example of FIG. 1, each flexible photovoltaic module 104 may include one module connector with two electrical conductive elements that are electrically connected to the photovoltaic cells of that flexible photovoltaic module is configured such that the energy generated by the flexible photovoltaic module may be transferred through the module connector. However, the electrical connection scheme is not limited to this and any appropriate connection scheme may be implemented.

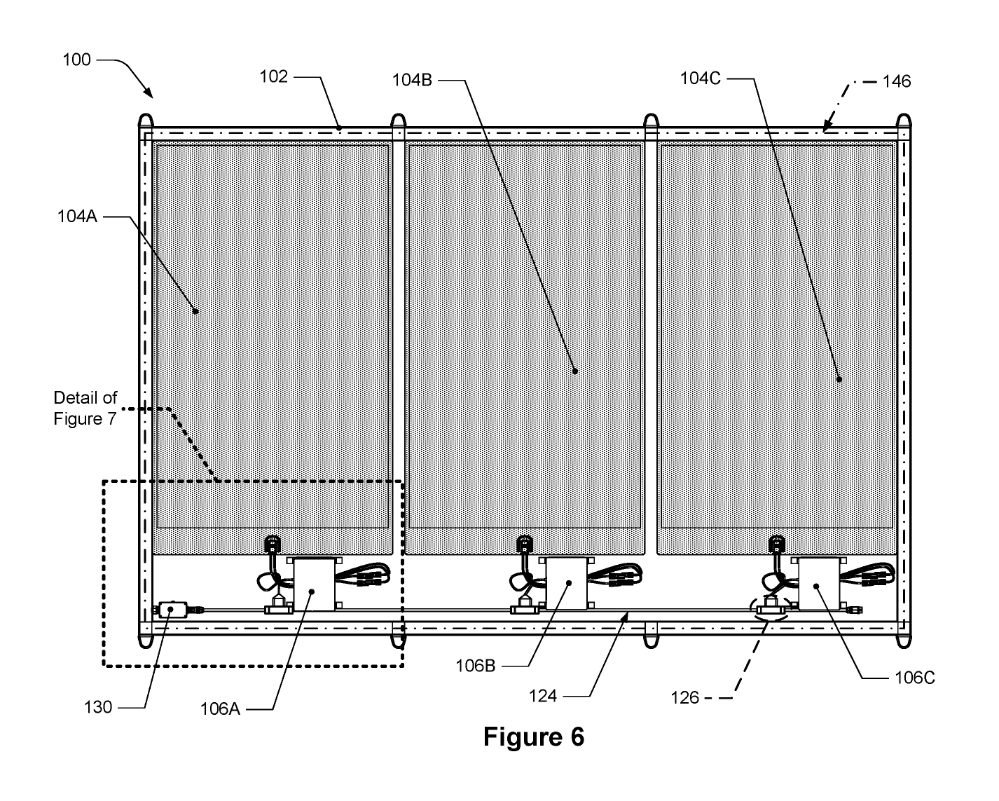

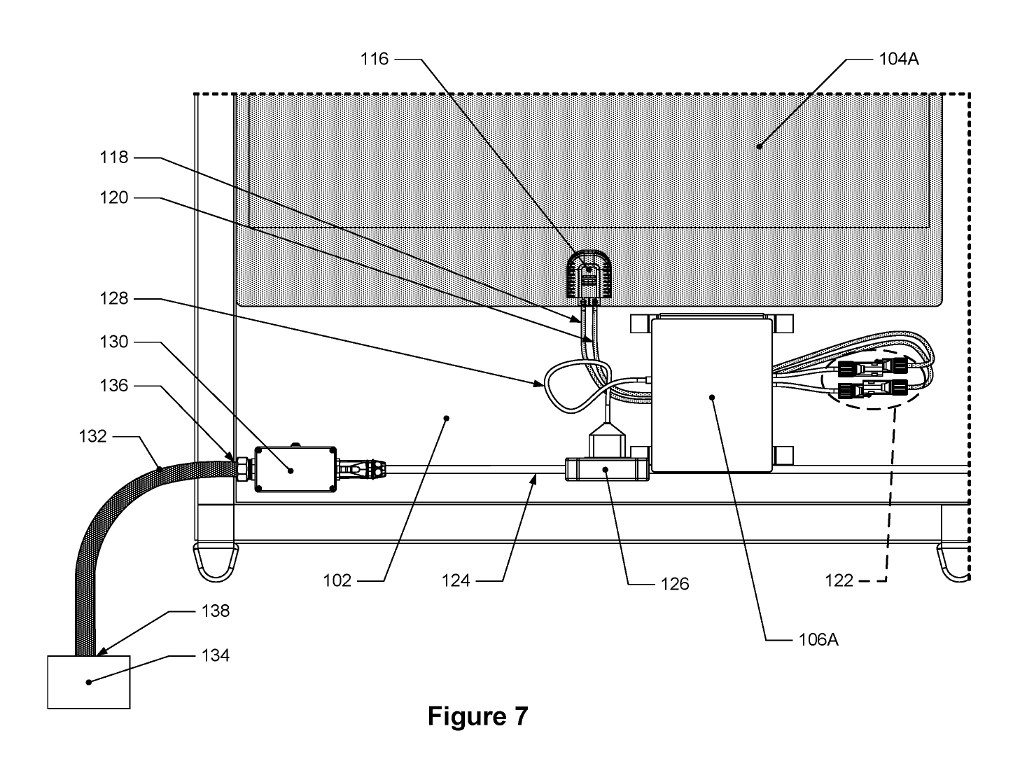

One example of the electrical connections of the apparatus will be explained using FIGS. 6 and 7; FIG. 6 depicts a plan view of some of the aspects of the apparatus of FIG. 1 and FIG. 7 depicts a detail view of a portion of the apparatus of FIG. 6. FIG. 6 does not depict the plurality of mounting features and the plurality of flexible connectors. As can be seen in FIG. 6 (and in FIG. 1), the apparatus 100 includes three flexible photovoltaic modules, identified as 104A, 104B, and 104C, and three corresponding inverters, identified as 106A, 106B, and 106C. Each of the flexible photovoltaic modules 104A, 104B, and 104C is electrically connected to a corresponding inverter 106A, 106B, and 106C, respectively, and one example electrical connection between an inverter and a flexible photovoltaic module is discussed with respect to FIG. 7.

In the detail view of FIG. 7, a portion of one the flexible photovoltaic module 104A can be seen along with a corresponding inverter 106A. The flexible photovoltaic module 104A includes a module connector 116 that has a first electrical conductive element 118 and a second electrical conductive element 120, both of which are electrically connected to the inverter 106A at two electrical connection points encircled at item 122. The module connector 116 may be considered a “Module Junction Box” or “Module J-Box” which may be permanently attached to the photovoltaic module 104A electrically by soldering the leads to the internal wiring of the photovoltaic module 104A and mechanically by bonding the module connector 116 to the photovoltaic module 104A using adhesives and potting. The module connector 116 may have leads, e.g., wires such as first electrical conductive element 118 and second electrical conductive element 120, that extend away from the module connector 116 and are configured to connect with connectors or such leads may have a connector where the interconnect wiring can be connected. The module connector 116 may have a housing that electrically isolates the voltage and provides connection to the Positive (+) and Negative (−) poles of the flexible photovoltaic module 104A.

It should be noted that in some embodiments, such as FIG. 6, the apparatus may have a number of inverters that matches the number of flexible photovoltaic modules, but in other embodiments, the numbers may not match; for example the apparatus may have three flexible photovoltaic modules and only one inverter to which all the flexible photovoltaic modules are electrically connected. Regardless of the numbers of inverters and flexible photovoltaic modules, the apparatus is configured such that each flexible photovoltaic is electrically connected to an inverter.

The apparatus may also include an electrical connector bus as seen in FIGS. 6 and 7. Referring back to FIG. 6, the electrical connector bus 124 may be an electrical cable or conduit that, among other things, extends along a portion of the flexible mounting substrate 102, includes provides electrical connection points 126 that are configured to electrically connect with the inverters 106A, 106B, and 106C, and includes a common electrical pathway for the energy generated by the flexible photovoltaic modules 104A, 104B, and 104C. In the detail view of FIG. 7, the electrical connector bus 124 and one of the electrical connection points 126 are shown and the inverter 106A is connected to the electrical connection point 126 by a first electrical jumper 128. The electrical connector bus 124 may be configured such that its electrical connection points 126 are wired in parallel. The electrical connector bus 124 may also be connected to the flexible mounting substrate 102 by any techniques known in the art, such as by adhesive or fastener.

The electrical connector bus 124 may also have a first end and a second end, with each end having an end electrical connector that may enable the electrical connector bus 124 to electrically and/or physically connect with other electrical connectors so that the energy generated by the flexible photovoltaic modules may be electrically connected to an external electrical circuit, such as a power grid. The first and second ends of the electrical connector bus 124 may also be configured to connect with a termination cable which electrically and physically connects with the first and/or second end of the electrical connector bus 124 and creates a termination point at the end of the electrical connector bus 124 to which the termination cable is connected.

The apparatus may also include an electrical junction box, identified as 130 in FIGS. 6 and 7, which may be connected to the flexible mounting substrate 102 and may be electrically connected to the inverters. For example, in FIG. 7, the flexible photovoltaic module 104A is electrically connected to the inverter 106A, the inverter 106A is electrically connected to the electrical connection point 126 of the electrical connector bus 124, and the electrical connector bus 124 is electrically connected to the electrical junction box 130. Therefore, the electrical junction box 130 is electrically connected to the flexible photovoltaic module 104A. Such electrical connections also similarly exist with respect to flexible photovoltaic modules 104B and 104C such that in the apparatus of FIG. 6, the electrical junction box 130 is electrically connected to the flexible photovoltaic modules 104A, 104B, and 104C. The electrical junction box 130 may provide a single electrical and/or physical connection point for a flexible electrical conduit.

The apparatus may further include a flexible electrical conduit which may serve as part of the electrical connection between the flexible photovoltaic modules and the external electrical circuit, such as a power grid. In some embodiments, the flexible electrical conduit may be electrically connected to aspects of the items that are attached to the flexible mounting substrate, such as the electrical connector bus, one or more inverters, one or more flexible photovoltaic modules, and/or the junction box; the flexible electrical conduit may also be physically connected to such features of the apparatus. For example, the electrical conduit may be electrically connected to one of the inverters that is connected to the flexible mounting substrate, and therefore electrically connected to one or more flexible photovoltaic modules electrically connected to that at least one inverter. As discussed in more detail below, the flexible electrical conduit may also extend away from the flexible mounting substrate and physically extend between the flexible mounting substrate and an external connection point (e.g., the external connection point not being located on the flexible mounting substrate), such as an external electrical circuit or power grid. The flexible electrical conduit may be a variety of flexible electrical conductors, but in some embodiments, the flexible electrical conduit may be waterproof and may include a metalclad layer and/or a PVC layer. The flexible electrical conduit may be configured to protect its internal electrical conductors from damage; such protection may be from mechanical wear or damage accomplished by the metal cladding, which may be a spiral metal sheath that provides armor, while also allowing the flexible electrical conduit to be flexible; the protection may also be from the elements, water and UV, by the combination of the metal sheath and an external PVC plastic sheath that may be a continuous tube that is both water tight and also UV protected. The flexibility of this flexible electrical conduit enables the rooftop system to be placed in a wide range of locations and enables the interconnection to the utility to be routed over the roof and along the structure. The flexible electrical conduit may also house the conductors of the system which may include a line, a neutral, and a ground conductor, as well as a sheath material that may also acts as a ground sheath.

For example, as seen in FIG. 7, the flexible electrical conduit 132 is electrically and physically connected to the electrical junction box 130, extends away from the flexible mounting substrate 102, and is electrically connected to an external electrical circuit 134, such as an electrical grid or a power grid. As noted above, such electrical connection to the junction box 130 also electrically connects the flexible electrical conduit 132 to the electrical connector bus 124, to the inverters 106 that are electrically connected to the electrical connector bus 124, and to the flexible photovoltaic modules 104 such that energy generated by the flexible photovoltaic modules 104 attached to the flexible mounting substrate is transported, at least in part, by the flexible electrical conduit to the external electrical circuit 134. As seen further in FIG. 7, the flexible electrical conduit 132 may include a first end 136 that is electrically and physically connected to the electrical junction box 130, which in turn electrically connects the flexible electrical conduit to the electrical connector bus 124, to the inverter 106A, and to the flexible photovoltaic module 104A. The flexible electrical conduit 132 may further include a second end 138 that is physically and electrically connected to the external circuit 134 which in turn enables the energy generated by the flexible photovoltaic modules 104 attached to the flexible mounting substrate to be transported, at least in part, by the flexible electrical conduit to the external electrical circuit 134. In some other example embodiments, the first end may be physically connected to other elements that are connected to the flexible mounting substrate 102, such as to one or more inverters 106 or to one or more flexible photovoltaic modules 104. As discussed in more detail below, a portion of the flexible conduit may also extend along and be connected to one flexible connector, like depicted in FIG. 1, for example.

In some embodiments, the apparatus may also include an alternating current (“AC”) disconnect. This AC disconnect may be electrically interposed between the flexible photovoltaic modules and the external electrical circuit to which the flexible photovoltaic modules are electrically connected. The AC disconnect may enable the AC current being transferred from the inverters to the external electrical circuit to be manually and/or automatically disconnected from the external electrical circuit. The AC disconnect may be positioned in a variety of locations, such as mounted on the structure (e.g., a wall of a house) or connected to the flexible mounting substrate. For example, the flexible electrical conduit may extend between the electrical junction box and the AC disconnect such that the second end terminates at the AC disconnect, e.g., the second end is physically and electrically connected to the AC disconnect.

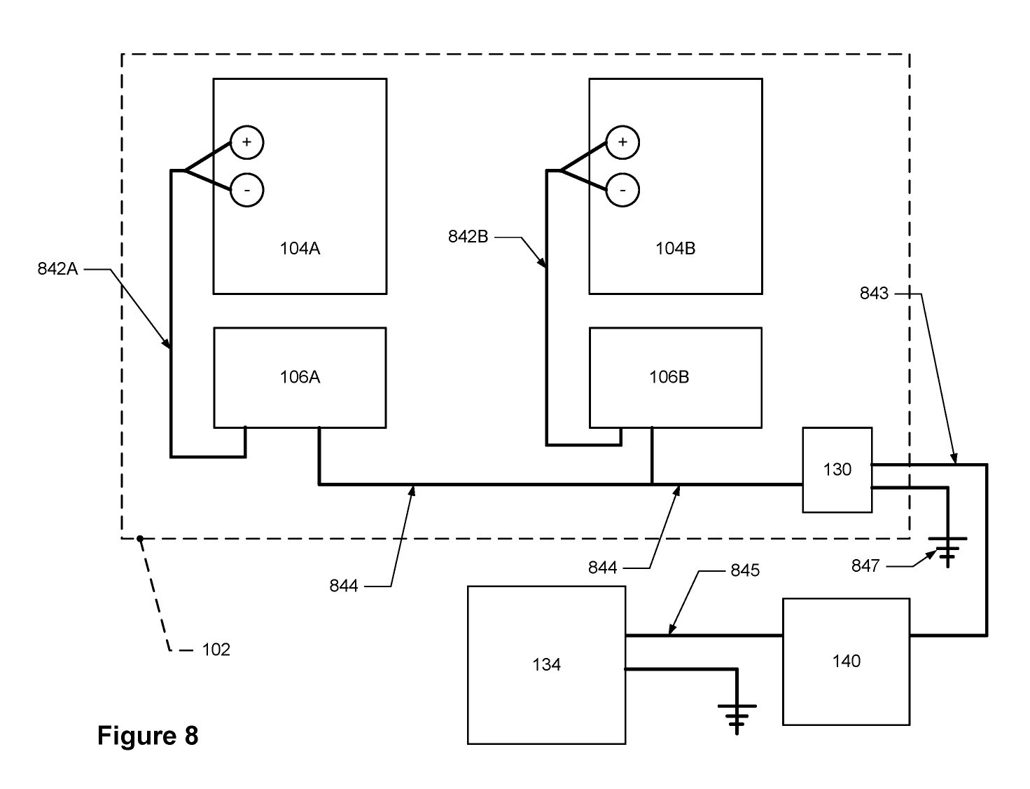

An example electrical configuration will now be discussed using FIG. 8 which depicts an example electrical circuit of the apparatus. FIG. 8 is intended to be a sample, representative electrical circuit of the apparatus to illustrate at least some of the electrical connections disclosed herein; such electrical configurations may vary in other embodiments. As can be seen in FIG. 8, the flexible photovoltaic module 104A is electrically connected to inverter 106A via electrical connection 842A such that the direct current (DC) generated by the flexible photovoltaic module 104A travels to inverter 106A. In some embodiments, electrical connection 842A includes the electrical pathway from the flexible photovoltaic module 104A to the inverter 106A via the module connector 116 that includes the first and second conductive elements, 118 and 120, respectively, the electrical connection points 122, and at least a part of the electrical connector bus 124. The flexible photovoltaic module 104B is identically connected to inverter 106B via electrical connection 842B.

The inverters 106A and 106B are electrically connected in parallel with the ground identified as 847. For instance, the AC output from inverter 106A may be electrically connected to an AC output of inverter 106B in parallel circuit connection via electrical connection 844 and the AC output from inverters 106A and 106B are electrically connected to the electrical junction box 130 via electrical connection 844; inverters 106A and 106B are electrically connected to a ground 847 via conductors within electrical connection 844 that are also electrically connected to the electrical junction box 130. The AC current of the inverters 106A and 106B may be electrically connected via an AC interconnect (not shown) and the AC current of the inverter 106B may be electrically connected to the electrical junction box 130 via another AC interconnect (also not shown). Such grounding conductors can also be made externally to electrical connection 844 if desired. Electrical connection 844 may also be described to include the first electrical jumper 128, electrical connection points 126, and electrical connector bus 124. Furthermore, the conductors may be arranged in the electrical connector bus 124 and electrical connection points 126 such that other inverter connections may be arranged in a parallel circuit configuration.

The electrical junction box 130 can be seen electrically connected to the AC disconnect 140 via electrical connection 843, which in some embodiments may be the flexible electrical conduit 132; the AC disconnect 140 is also electrically connected to the external electrical circuit 134 via electrical connection 845. As noted above, the electrical connections between the inverters 106A and 106B and the electrical junction box 130 may be made using the electrical connector bus 124. It should also be noted that in this example embodiment, the elements and electrical connections that are made and occur on the flexible mounting substrate 102 are depicted within the dashed box 102 in FIG. 8.

Referring back to FIGS. 2 and 6, it should be noted that in some embodiments, some of the components described herein may be considered on and within the boundary of the flexible mounting substrate. For example, the top side 115 of the flexible mounting substrate 102 identified in FIG. 2 inherently includes an outer boundary which may be, for example as depicted in FIGS. 2 and 6, a substantially rectangular shape (e.g., some corners may be rounded and the top side may not have sides that meet at 90 degrees, but rather within +/−5 degrees of normal). When viewed at an angle normal to the top side 115, such as the angle depicted in FIG. 6, some components of the apparatus may be connected to the flexible mounting substrate 102 such that they are positioned within the boundary of the top side 115. In FIG. 6, a boundary line 146 is seen with a dash-dot-dash line and represents a boundary of the top side 115 of the flexible mounting substrate, but for clarity of viewing purposes, the boundary line 146 is depicted slightly smaller than and inside the actual boundary of the flexible mounting substrate. As can be seen in FIG. 6, the flexible photovoltaic modules 104A, 104B, and 104C, the inverters 106A, 106B, and 106C, the electrical connector bus 124, electrical connections between these components, and the electrical junction box 130 are all connected to the flexible mounting substrate 102 such that they are within the boundary 146 of the top side 115 of the flexible mounting substrate 102 when viewed at an angle normal to the top side 115.

With regard to the flexible mounting substrate 102, it is a flexible substrate that may be made from any of variety of materials, such as a monofilament high density polyethylene (“HDPE”), such that it is flexible and not rigid. The flexible mounting substrate 102 may be configured to be strong, light weight (e.g., less than about 1 pound per square foot), flexible (capable of being bent to make a U-shape with a radius of approximately the material thickness without breaking the flexible mounting substrate and without causing plastic deformation to the flexible mounting substrate), breathable, and weather resistant. An average person using moderate force may be capable of bending the flexible mounting substrate.

For example, the flexible mounting substrate 102 may also be configured such that it is able to withstand a particular stress and/or force threshold, such as a wind pressure rating of minus 12 psf, as well as a maximum force of about 1,464 pound-force (lb_{f}) or about 939 lb_{f}. In some embodiments, the flexible mounting substrate 102 may be a breathable fabric, such as a mesh material, it may be fire resistant, it may have UV protection. For example, the flexible mounting substrate may be a round monofilament HDPE yarn that is fire retardant with UV protection. The flexible mounting substrate 102 is also configured such that components, such as the flexible photovoltaic modules and inverter frames for the inverters, can be attached to the flexible mounting substrate. In other examples, the flexible mounting substrate 102 may be a flexible substrate made of stitched webbing to form a “net,” a wire net, a metal chain link mesh, thin sheets of plastic, that may be molded into various shapes, corrugations or otherwise, or a Thermoplastic Polyolefin (TPO) membrane.

In some embodiments, the apparatus may also include a cover that may be configured to cover some items attached to the flexible mounting substrate. Such configuration may cause the cover to at least partially enclose the items so that the cover blocks those items from direct sunlight. This configuration may also cause the items to be interposed between the cover and the flexible mounting substrate when viewed from an angle parallel to the top surface of the flexible mounting substrate. The cover may also be removable such that it can be easily removed from the flexible mounting substrate in a non-destructive manner, e.g., it may be attached to the flexible mounting substrate using snaps or hook and loop fasteners, such as Velcro™. The cover may also be configured to enable electrical cabling to enter and exit the cover through one or more access holes and, in some embodiments, preventing larger sections of cabling, e.g., the electrical junction box, from passing through the access holes. The access holes may be further configured to prevent or reduce the ingress of debris and animals.

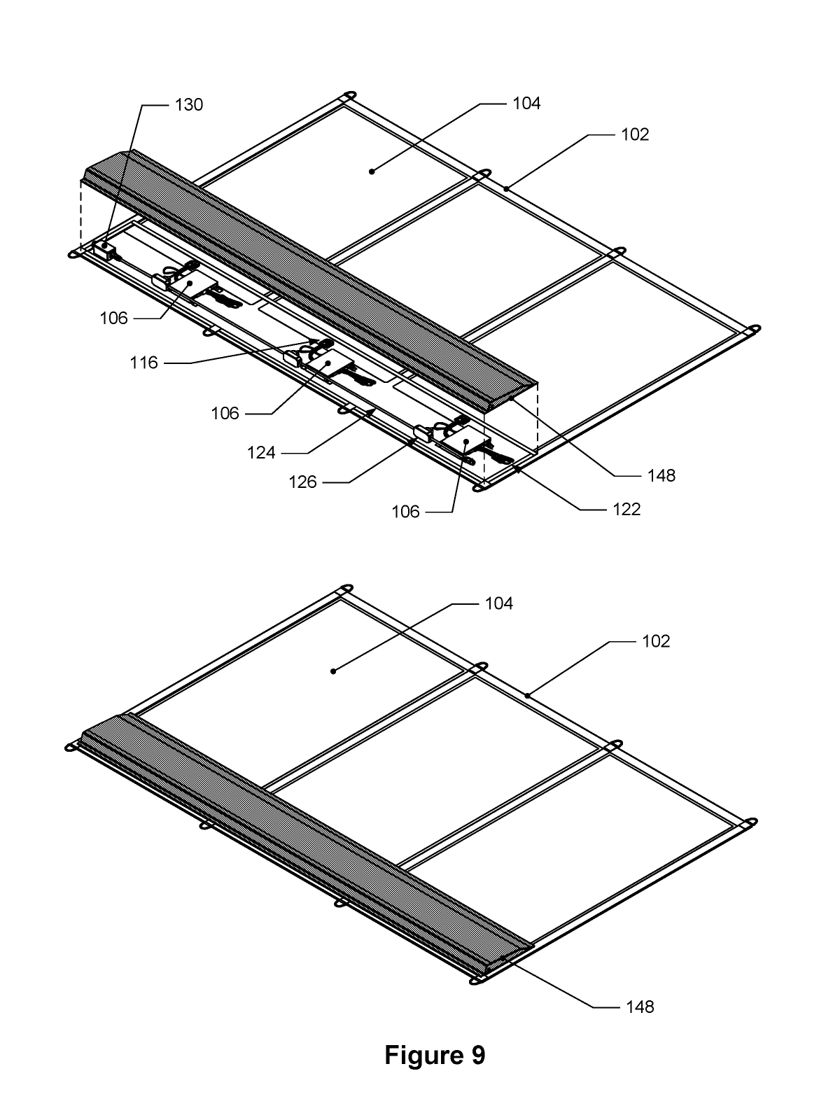

FIG. 9 depicts two isometric views of aspects of the apparatus of FIG. 1 with a cover. FIG. 9 does not depict the plurality of mounting features and the plurality of flexible connectors. As can be seen in the top exploded view, the cover 148 (highlighted with shading) is above a portion of the flexible mounting substrate 102, e.g., above a portion of the top side of the flexible mounting substrate, and above at least some items attached to the flexible mounting substrate 102, such as the inverters 106, the module connectors 116, the first and second conductive elements of the module connectors 116 (not identified), the electrical connector bus 124, electrical connection points 126 on the electrical connector bus, and electrical connection points between these components (e.g., electrical connection points 122), and the electrical junction box 130. In the bottom non-exploded view, the cover 148 is attached to the flexible mounting substrate 102 such that the cover 148 encloses the aforementioned items, e.g., the inverters 106, the electrical connector bus 124, electrical connections between these components, and the electrical junction box 130. The cover 148 may also cover a portion of the flexible photovoltaic modules 104 that contains the module connector 116.

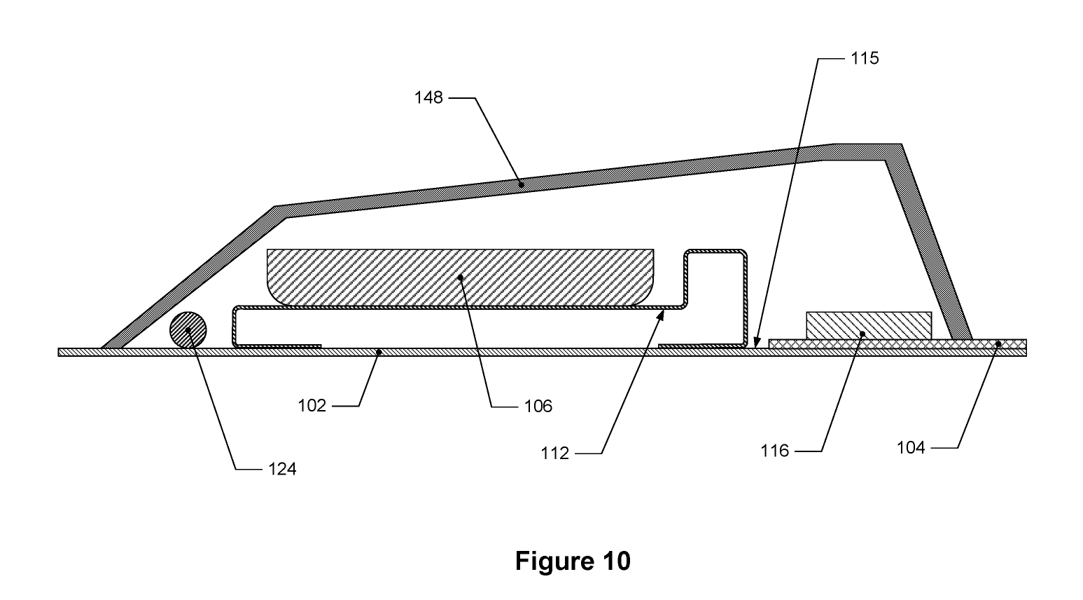

FIG. 10 depicts a partial cross-sectional view of the apparatus of FIG. 9. The Figure is similar to FIG. 5 and includes some example apparatus items, such as an inverter 106, an inverter frame 112, a module connector 116, and an electrical connector bus 124. The view of FIG. 5 is at an angle parallel to the top side 115 of the flexible mounting substrate 102. As can be seen in FIG. 10, the inverter 106, the inverter frame 112, the module connector 116, and the electrical connector bus 124 are covered and at least partially enclosed by the cover 148, as well as interposed between the cover 148 and the flexible mounting substrate 102.

As mentioned above, the apparatus 100 is configured to be placed on or over a structure, such as on or over the roof of the structure, and secured to the structure using mounting features that are configured not to penetrate the roofing. Referring back to FIG. 1, the apparatus includes a plurality of mounting features 108 that are configured to be attached to a structure; each of the mounting features 108 are configured to secure the flexible mounting substrate above, e.g., on or over, the structure, such as the roof, without penetrating the roofing. In some embodiments, the mounting features 108 are connected to the flexible mounting substrate 102 by the flexible connectors 110, as can be seen in FIG. 1. Each flexible connector 110 extends between the flexible mounting substrate 102 and one corresponding mounting feature 108, as also depicted in FIG. 1. In some embodiments, more two or more flexible connectors 110 may extend between one mounting feature 108 and the flexible mounting substrate 102. The number of flexible connectors 110 may depend on the structural requirements of the apparatus and the structure.

The flexible connectors 110 may be a variety of materials, such as straps made of a fabric (e.g., HDPE or polyester) or cables made of a metal or metals (e.g., galvanized steel cables). The flexible connectors may be configured such that they are able to withstand a particular stress and/or force threshold, such as a wind pressure rating of minus 12 pounds-force per square inch (psf), as well as a maximum force of about 1,464 lb_{f} or about 939 lb_{f}. For example, the flexible connectors 110 may be 3/16 diameter galvanized steel with a 4,200 lb_{f} minimum breaking strength. The flexible connectors 110 may be connected to the flexible mounting substrate in any manner known in the art, such as using cable loops and fasteners, clips, D-ring, or other suitable methods and materials.

The flexible mounting substrate, as seen in FIG. 1, may also include a plurality of anchor points 150 which may be the points of the flexible mounting substrate 102 to which the flexible connectors 110 attach to the flexible mounting substrate 102, such as D-rings or holes; these anchor points 150 may be configured in any suitable manner, including the ability to withstand a particular stress and/or force threshold, such as a maximum force of about 1,464 lb_{f} or about 939 lb_{f}, for example. There may also be a minimum number of anchor points 150 included on the flexible mounting substrate 102, which may be about eight, like depicted in FIG. 1. The number of anchor points 150 may be determined, at least in part, on the surface area of the flexible mounting substrate 102. For example, a flexible mounting substrate that is approximately 7 feet by 10 feet may have a minimum of eight anchor points.

In some embodiments, the apparatus, including the flexible mounting substrate 102, the anchor points 150, the flexible connectors 110, and the mounting features 108, may be configured to withstand roof loading ratings consistent with building codes and other standards in a geographical location in which the apparatus will be located, such as the county or state building codes.

The mounting features of the apparatus will now be discussed. As stated above, the mounting features are configured to secure the flexible mounting substrate about the structure without penetrating the roofing. As indicated above, “roofing” means the external upper covering of the roof and includes the material for constructing a building's roof, such as tar, tar paper, shingles, slate, and tin, for instance; roofing also includes the material of the roof which forms a waterproof (or water-resistant) barrier between the external environment above the roof and the inside of the structure.

Developing mounting features that are configured to secure the flexible mounting substrate about the structure without penetrating the roofing presented unique and difficult challenges which required extensive design and effort that resulted in the unexpected results of the mounting features disclosed herein. While numerous mounting features are presented herein, these example mounting features are non-limiting. The disclosure is intended to encompass other mounting features which are configured to secure the flexible mounting substrate about the structure without penetrating the roofing.

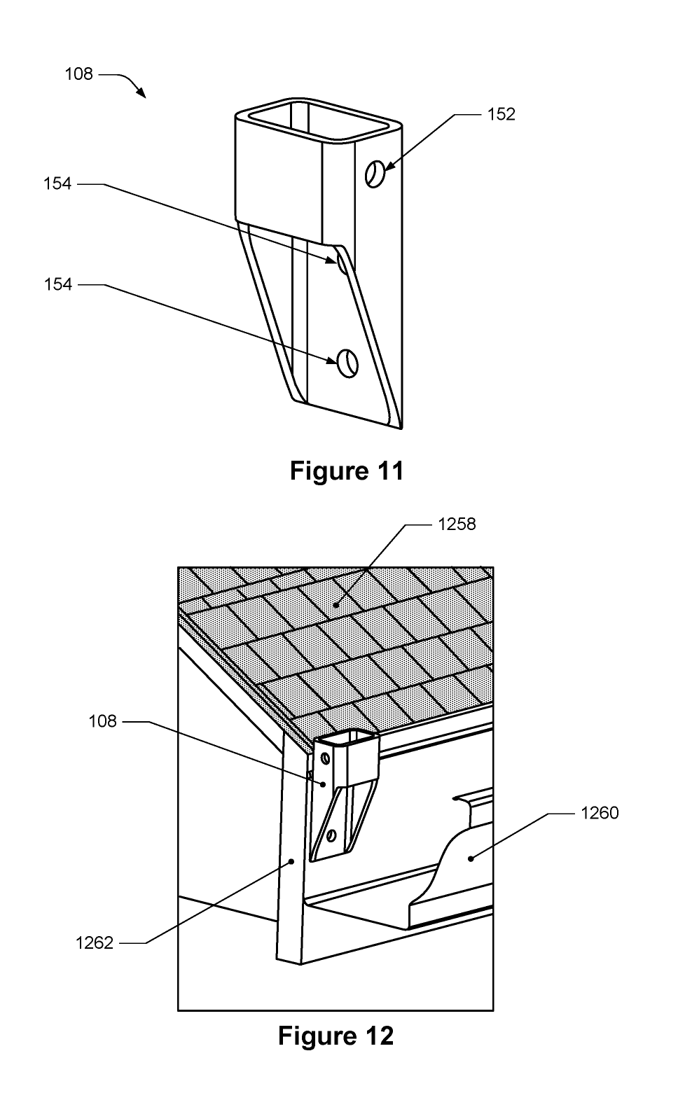

In some embodiments, each mounting feature may include at least one securement point which is configured to connect with a flexible connector and at least one attachment point which is configured to enable the attachment of the mounting feature to the structure, e.g., configured to be attached to one or more parts of the structure. The mounting features may be attached to various portions of the structure, such as walls, rafters, decking, barge board, fascia board, for example. FIG. 11 depicts an off-angle view of the example mounting feature of FIG. 1. As can be seen, the mounting feature of FIG. 11 includes at least one securement point 152 which is a hole through a part of the mounting feature 108. This securement point 152 is configured to connect with a flexible connector, which may occur, for instance, by having the flexible connector extend through and around the hole to form a loop which can be fastened together. The mounting feature 108 also includes two attachment points 154, which in this case are two holes, that are configured to enable the attachment of the mounting feature 108 to the structure. Here for instance, screws may be placed through the two attachment points 154 and into an exposed rafter of the structure which secures the mounting feature 108 to the structure without penetrating the roofing.

FIG. 12 depicts the example mounting feature of FIG. 11 secured to a part of a structure. In FIG. 12, a part of a structure can be seen that includes roofing 1258 (identified with shading), a part of a gutter 1260, mounting feature 108, and a fascia board 1262. The mounting feature 108 may be secured to the fascia board 1262 by screws, clamps, bolts, or any suitable fastening means, which does not penetrate the roofing 1258. This securement may penetrate the fascia board 1262 and the gutter 1260, but while the fascia board 1262 and the gutter 1260 may be considered parts of the roof, they are not parts of the roofing and not parts that forms a waterproof seal of the roofing. Therefore, this securement attaches the mounting feature 108 to the structure without penetrating the roofing 1258. Because the flexible mounting substrate is connected to the plurality of mounting features by the flexible connectors, the flexible mounting substrate is secured to the structure by the plurality of mounting features without penetrating the roofing; this securement of the flexible mounting substrate thus enables the items attached and connected to the flexible mounting substrate to be secured onto or above the structure.

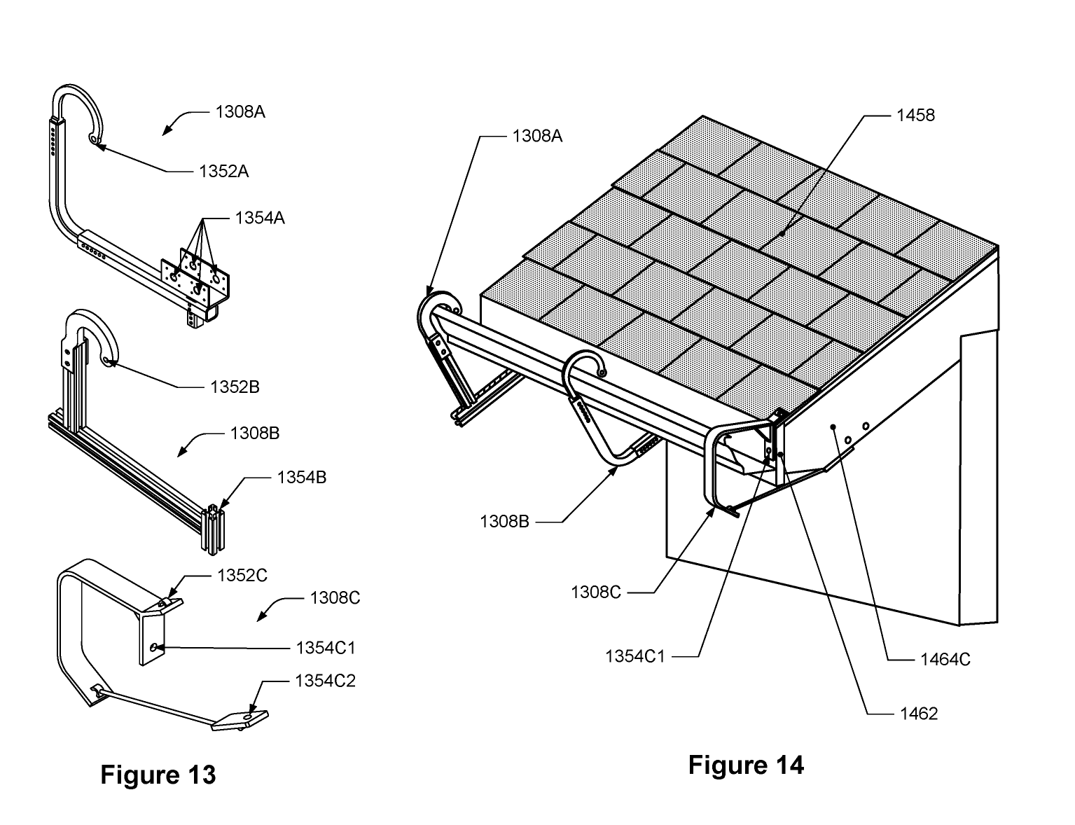

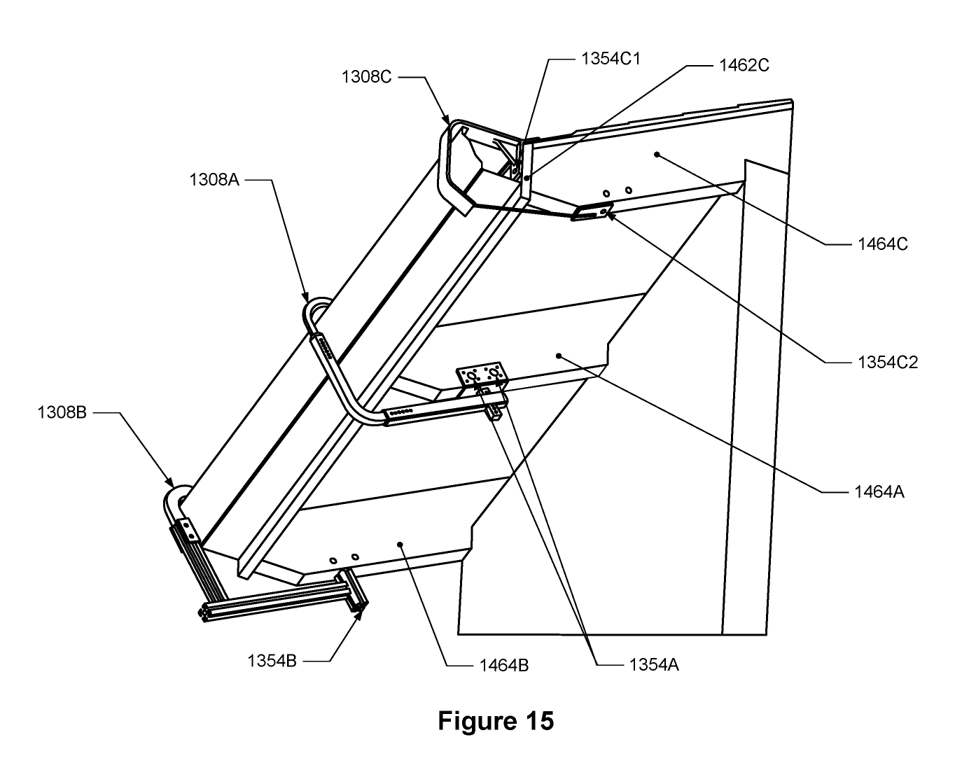

FIG. 13 depicts three other example mounting features and FIGS. 14 and 15 depict off-angle views of the three other example mounting features of FIG. 13 attached to a structure. As can be seen in FIG. 13, the three example mounting features, 1308A, 1308B, and 1308C each include at least one securement point 1352A, 1352B, and 1352C, respectively, which is configured to connect with a flexible connector and at least one attachment point, 1354A, 1354B, and 1354C, respectively, which is configured to enable the attachment of the mounting feature to the structure. The connection points and the securement points of the example mounting features may differ, as show in FIG. 13. For instance, the securement points 1352A and 1352B are holes while securement point 1352C is a differently shaped and configured hole. Additionally, the example mounting feature 1308A includes four attachment points 1354A and a bracket configuration that is configured to extend around a part of a rafter or beam of the structure; example mounting feature 1308B includes a different attachment mechanism 1354B; and example mounting feature 1308C includes two attachment points, with attachment point 1354C1 configured to be attached to a different part of the structure than attachment point 1354C2. Example mounting feature 1308C also includes multiple parts which may be connected to each other by a cable or bar.

In FIGS. 14 and 15, another example structure is shown and includes roofing 1458 and three separate rafters 1464A, 1464B, and 1464C (although only one rafter, 1464C, is depicted in FIG. 14) and fascia board 1462. The three example mounting features, 1308A, 1308B, and 1308C can be seen attached to the three separate rafters, respectively. In FIGS. 14 and 15, attachment point 1354C1 of example mounting feature 1308C can also be seen attached to fascia board 1462 while attachment point 1354C2 is attached to rafter 1464C. It can also be seen that the attachment points 1354A and 1354B of mounting features 1308A and 1308B, respectively, are only attached to rafters 1464A and 1464B, respectively.

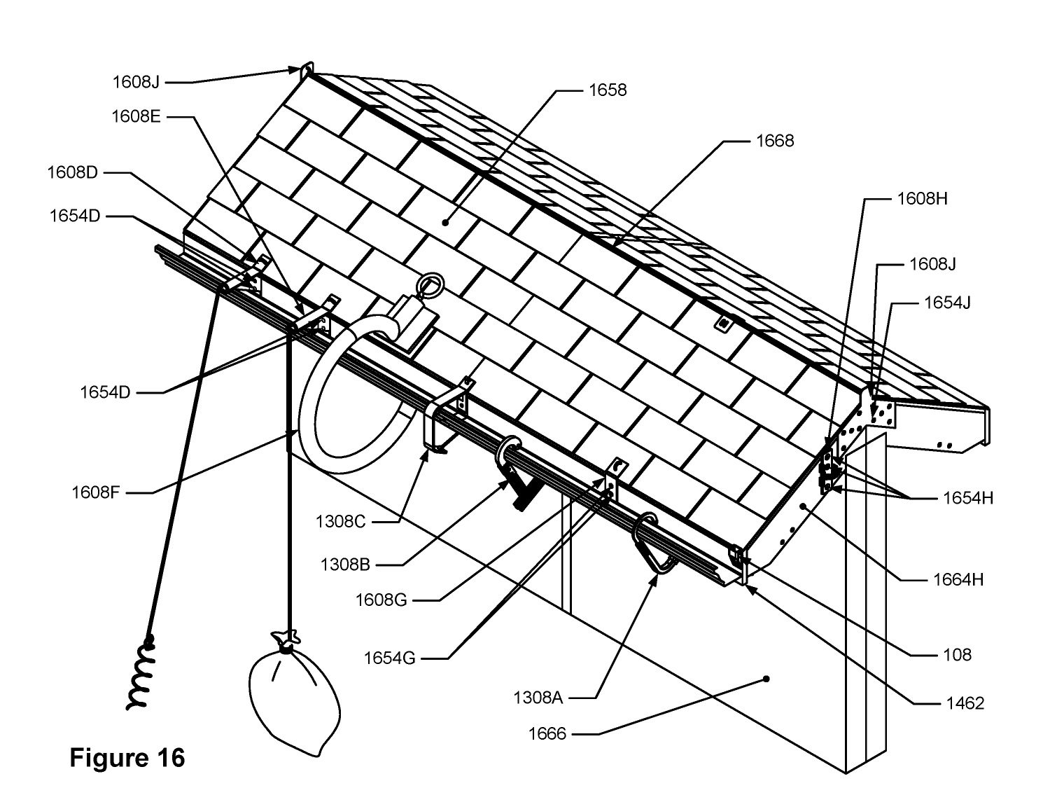

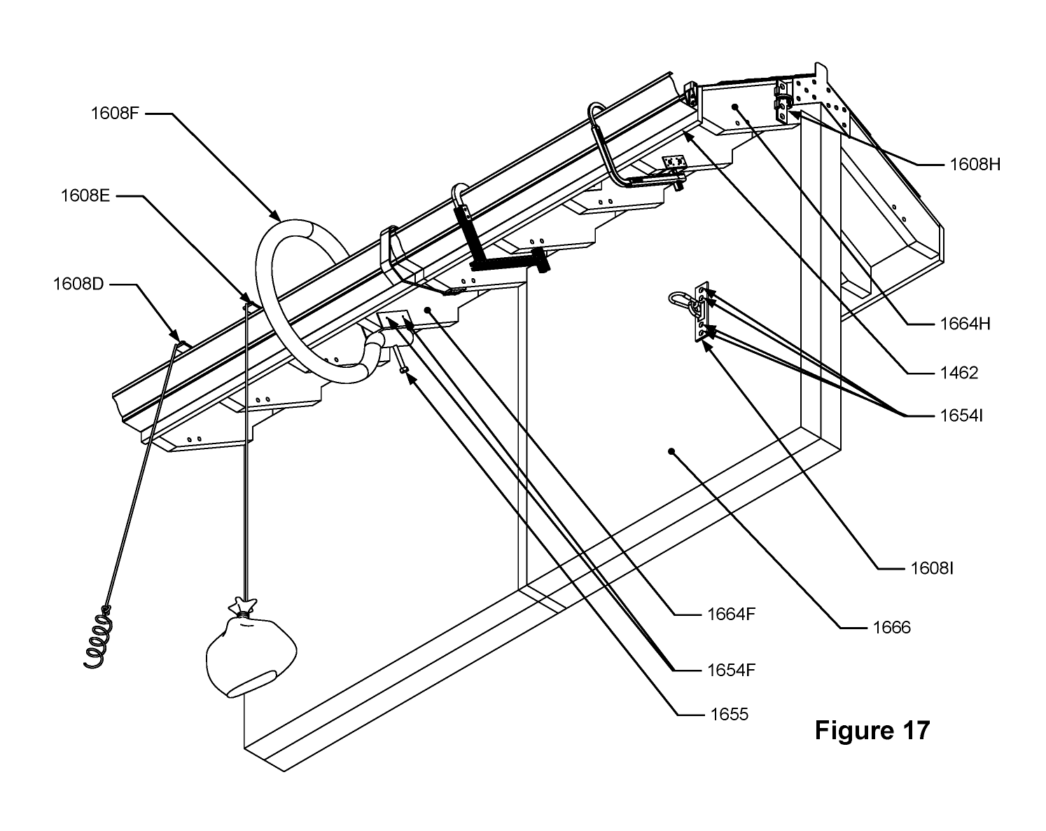

FIGS. 16 and 17 depict two off-angle views of additional example mounting features attached to another example structure. The structure includes rafters, including labeled rafters 1664F and 1664H, as well as wall 1666, fascia board 1462, and roofing 1658. As can be seen in the Figures, the securement points and attachment points of each example mounting features 1608D, 1608E, 1608F, 1608G, 1608H, 1608I, and 1608J are labeled therein as well as the part of the structure to which they are attached; example mounting features 108, 1308A, 1308B, 1308C are identified in FIG. 16, but their features are not individually labeled. As stated above, the attachment points of each example mounting feature are configured to enable the attachment of the mounting feature to the structure without penetrating the roofing of the structure.

For instance, example mounting features 108, 1608D, 1608E, and 1608G include attachment points that are configured to be attached only to the fascia board 1462; example mounting features 1308A, 1308B, 1608F, and 1608H include attachment points that are configured to be attached only to a corresponding rafter (e.g., mounting feature 1608F is attached to rafter 1664F, for example by an adjustment bolt 1655, and mounting feature 1608H is attached to rafter 1664H); example mounting feature 1308C includes an attachment point that is configured to be attached to two different parts of structure, e.g., the fascia board 1462 and rafter 1664C; example mounting feature 1608I (seen only in FIG. 17) is configured to be attached to a wall 1666, rafter, fascia board, or other flat surface of the structure. Example mounting feature 1608J (seen only in FIG. 16) is configured to have at least three parts, with two first parts attached to aspects of the structure on opposite sides of the structure (e.g., mounting feature 1608) is attached to rafter 1664H) and a third part, such as a bar or cable, that is connected to and extends between the other two parts such that the third part may act as the securement point; one attachment point 1654J of one first part is seen in FIG. 16 and the third part is identified as 1668. Example mounting features 1608D and 1608E also include attachment features that may be configured to be attached to an item via a cable, strap, pole, or other item. These items may be located on or off the structure, such as connected to the ground via a threaded stake (e.g., example mounting feature 1608D), to a pole or other fixed object, or to a sandbag (e.g., example mounting feature 1608E).

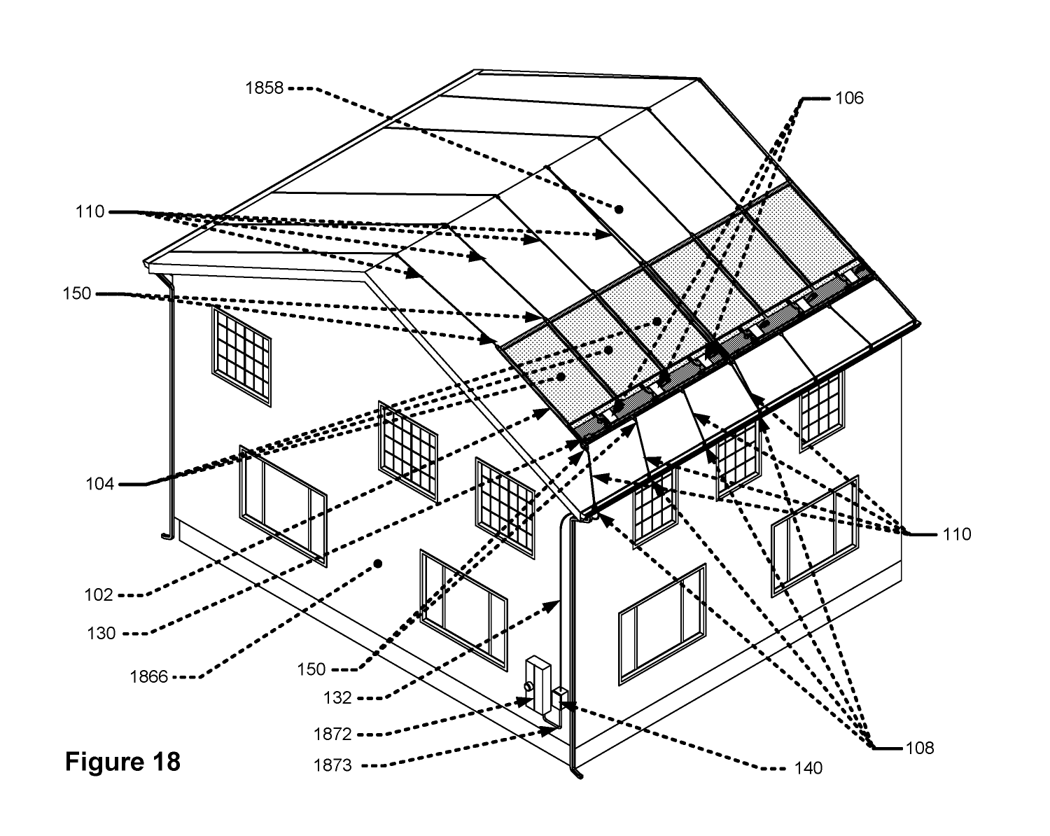

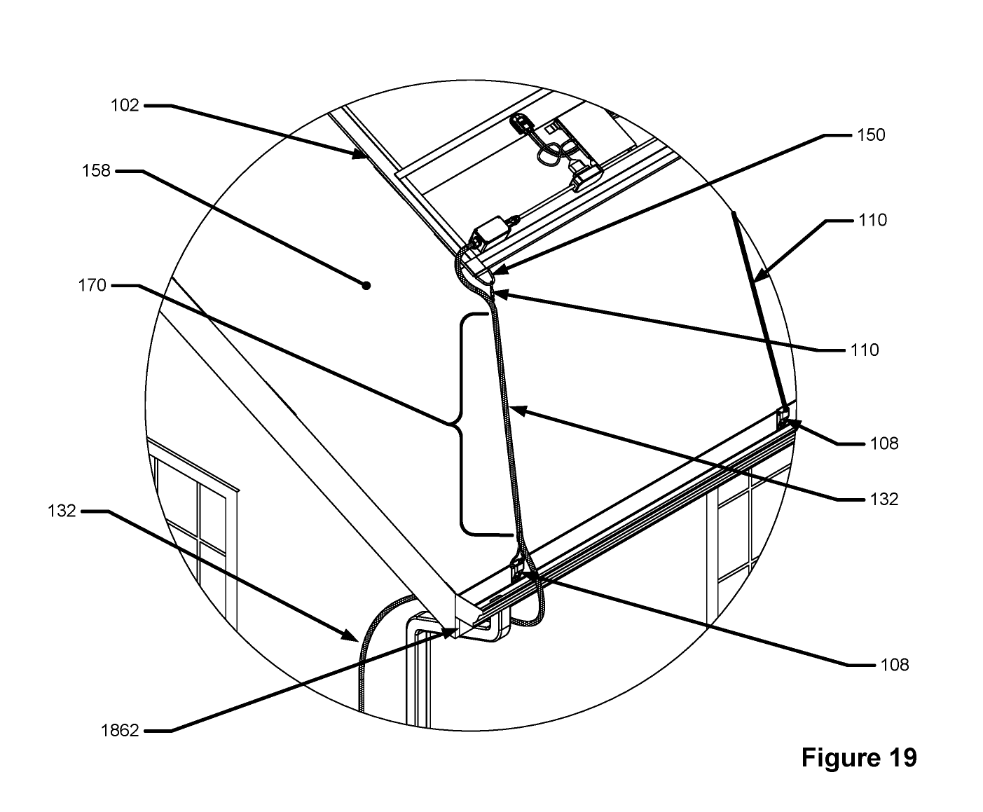

FIG. 18 depicts an isometric view of the example apparatus of FIG. 1 secured to an example house. The example apparatus of FIG. 18 is intended to encompass and represent the apparatuses and various configurations of the apparatuses disclosed herein, such as those described with respect to FIGS. 1 through 8. The identifiers are depicted as dotted lines for clarity purposes. Additionally, for example, even though FIG. 18 may not clearly depict all the features of the example apparatus of FIG. 1, the apparatus depicted in FIG. 18 includes the flexible mounting substrate 102, three flexible photovoltaic modules 104 attached to the flexible mounting substrate 102 and electrically connected to three inverters 106 which are connected to the flexible mounting substrate, an electrical junction box 130 attached to the flexible mounting substrate 102 and electrically connected to the three inverters 106, a flexible electrical conduit 132 with the first end electrically connected to the electrical junction box 130 and therefore electrically connected to the inverters 106 and to the flexible photovoltaic modules 104, eight anchor points 150, a plurality of mounting features 108, and a plurality of flexible connectors 110 arranged such that each flexible connector 110 extends between the flexible mounting substrate 102 and one corresponding mounting feature 108.

As can be seen in FIG. 18, the flexible mounting substrate 102 has been positioned above the roof, including above the roofing 1858, of the house. In some embodiments, the flexible mounting substrate 102 may be positioned on the roof and/or on the roofing 1858.

In some embodiments, the flexible mounting substrate 102 may be positioned directly on, and may be in direct physical contact with, one or more portions of a roof of a structure. In some such embodiments, a back side of the flexible mounting substrate may be facing the roofing of the structure while the top side 115 is facing away from the roofing. Such positioning may also include placing the flexible mounting substrate over the structure but not contacting the roofing such that the flexible mounting substrate is offset from the roofing by a second offset distance. The eight mounting features 108, which are the mounting features described herein above with regard to FIGS. 11 and 12, are attached to the structure of the house and not penetrating the roofing 1858 of the house.

Some such mounting features 108 are identified and may be seen more clearly in the detail FIG. 19 which depicts a detail view of a part of FIG. 18. These mounting features 108 are attached to the structure like in FIG. 12, which is attached to the fascia board 1862 of the house. Such mounting, as discussed above, does not penetrate the roofing 1858 of the house. Each of the eight flexible connectors 110 extend between one anchor point 150 of the flexible mounting substrate 102 and one corresponding mounting feature 108. This configuration of the apparatus thereby enables the flexible mounting substrate 102 to be secured above, e.g., on top of, the roofing 1858 of the house without any penetration of the roofing 1858 of the house.

As can be seen in FIGS. 18 and 19, the flexible electrical conduit 132 extends away from the flexible mounting substrate with a portion 170 of the flexible electrical conduit 132 extending along and physically connected to one of the flexible connectors 110. This physical connection may be made using suitable means, such as adhesives, clips, or fasteners. In FIG. 18, the flexible electrical conduit 132 can be seen extending down the house and in some embodiments, other portions of the flexible electrical conduit 132 may also be attached to the house or structure, e.g., attached to the wall 1866 of the house. An AC disconnect 140 is also seen in FIG. 18 attached to the wall 1866 of the house. The second end of the flexible electrical conduit 132 terminates at the AC disconnect 140 such that, like described above, the electricity generated by the flexible photovoltaic modules is electrically connected to the inverters 106 and the inverters 106 are electrically connected to the AC disconnect 140 through the flexible electrical conduit 132. The AC disconnect 140 is electrically connected to the electrical panel 1872 of the house which may be electrically connected to a power grid. The electric panel or power grid may be considered the external electrical circuit discussed herein above, e.g., item 134 in FIG. 7, to which the flexible conduit 132 is electrically connected via the AC disconnect 140 and an interconnection 1873 between the AC disconnect 140 and the electric panel 1872.

Although not depicted in FIG. 18, it is also contemplated that in some embodiments, the second end of the flexible electrical conduit may be electrically connected to an outlet, e.g., electrical socket, of a structure or of an electrical circuit. For instance, the flexible electrical conduit may be electrically and physically connected to a 220V-30 A receptacle of the structure such that the electricity generated by the flexible photovoltaic modules is electrically connected to the inverters 106 and the inverters 106 are electrically connected to the 220V-30 A receptacle through the flexible electrical conduit 132. In some such embodiments, an AC disconnect or other circuit breaker may be electrically interposed between the flexible electrical conduit and the 220V-30 A receptacle.

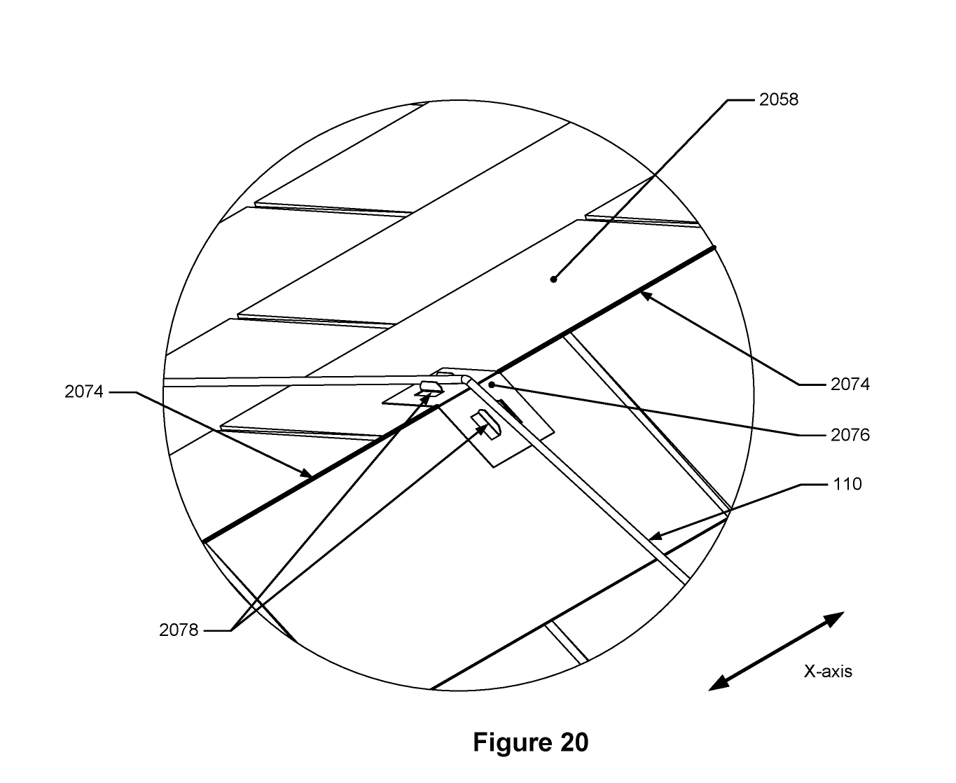

When a flexible connector extends over a ridge or crest of a roof, including the roofing, damage may occur to the flexible connector and/or the roof. Therefore, in some embodiments, the apparatus may include a ridge protector which is configured to be positioned onto a ridge or other uneven surface of the roof such that the ridge protector is interposed between a flexible connector and the roof such and thereby configured to prevent contact between roofing material, e.g., the ridge, and the flexible connector. The ridge protector is also configured to dissipate forces normal to the ridge, that are caused by the tension of the flexible connector 110, over a larger area of the roof than the surface area of the flexible connector 110 such that damage or long term wear may be reduced or eliminated. FIG. 20 depicts a detail, isometric view of a ridge of an example house with an example ridge protector and a flexible connector. As can be seen, the house includes roofing 2058 that has a ridge 2074 over which a flexible connector 110 extends. A ridge protector 2076, that is configured to prevent contact between the ridge 2074 and the flexible connector 110, has been positioned on the ridge such that the ridge protector 2076 is interposed between the ridge 2074 and the flexible connector 110 and the ridge protector 2076 and there is no contact between the ridge 2074 and the flexible connector 110. In some embodiments, the ridge protector 2076 may also include one or more aligning features 2078 that are configured to maintain, confine, and/or align the flexible connector 110 in a particular position, location, and/or zone of the ridge protector 2076, as can be seen in FIG. 20. Here, the aligning features 2078 are raised flanges that may prevent the flexible connector 110 from moving a particular distance along the labeled x-axis.

In some embodiments, the apparatus may be arranged such that flexible connectors 110 do not extend over a ridge of a roof and the flexible mounting substrate itself extends over a ridge of a roof. In such embodiments, some anchor points of the flexible mounting substrate may be positioned on one side of the ridge while other anchor points of the flexible mounting substrate are positioned on the other side of the ridge.

The apparatus disclosed herein may also include two or more flexible mounting substrates, with each flexible mounting substrate including at least one or more flexible photovoltaic modules attached to the flexible mounting substrate, one or more inverters which are connected to the flexible mounting substrate and electrically connected to the one or more flexible photovoltaic modules that are attached to that flexible mounting substrate, a plurality of mounting features, and a plurality of flexible connectors that extend between each flexible mounting substrate and one corresponding mounting feature; these items are configured on each flexible mounting substrate as described hereinabove, such as with regard to FIGS. 1 to 8, and each flexible mounting substrate with these items configured as described above is referred to herein as a “unit.” In addition to these items, each unit may also include some or all of the features described hereinabove.

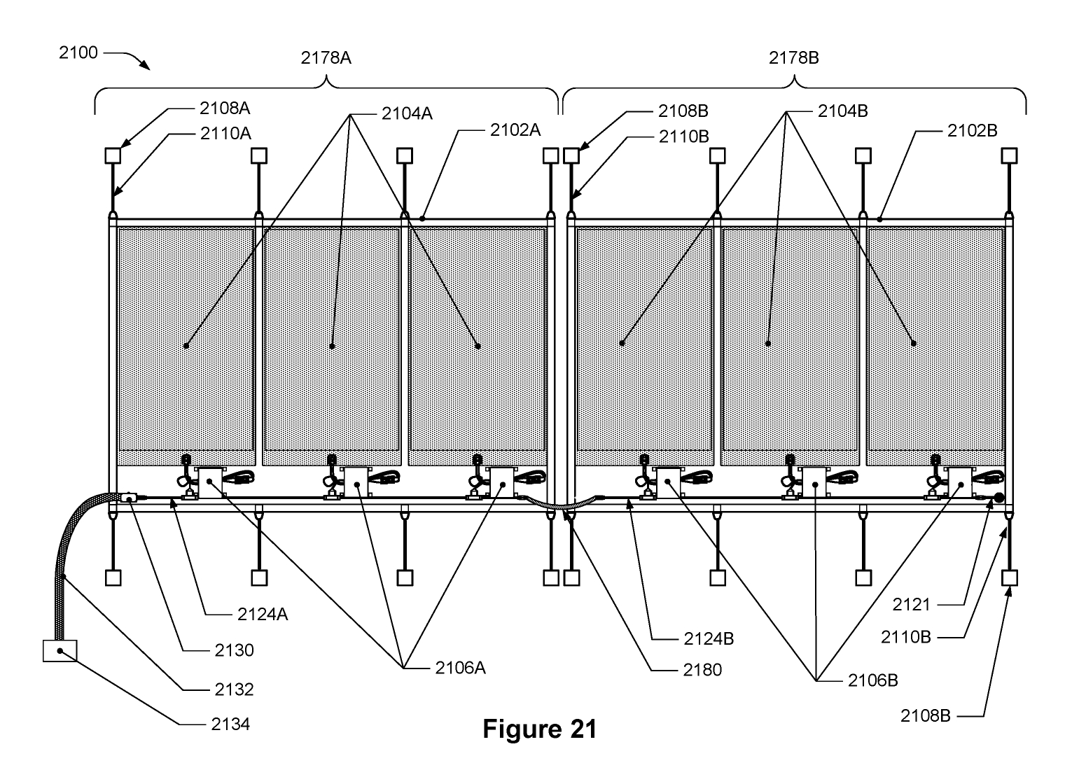

FIG. 21 depicts another example embodiment of the apparatus. The apparatus 2100 of FIG. 21 includes two units, unit 2178A and 2178B, with the first unit 2178A having a first flexible mounting substrate 2102A, three first flexible photovoltaic modules 2104A attached to the first flexible mounting substrate 2102A, three first inverters 2106A connected to the first flexible mounting substrate 2102A and electrically connected to the three first flexible photovoltaic modules 2104A, a plurality (e.g., eight in FIG. 21) of first mounting features 2108A, and a plurality (e.g., eight in FIG. 21) of first flexible connectors 2110A that extend between the first flexible mounting substrate 2102A and one corresponding first mounting feature 2108A. The first mounting features 108A, like described above, are configured to be attached to a structure and to secure the unit 2178A to the structure without penetrating the roofing of the structure.

The second unit 2178B has a second flexible mounting substrate 2102B, three second flexible photovoltaic modules 2104B attached to the second flexible mounting substrate 2102B, three second inverters 2106B connected to the second flexible mounting substrate 2102B and electrically connected to the three second flexible photovoltaic modules 2104B, a plurality (e.g., eight in FIG. 21) of second mounting features 2108B, and a plurality (e.g., eight in FIG. 21) of second flexible connectors 2110B that extend between the second flexible mounting substrate 2102B and one corresponding first mounting feature 2108B. The second mounting features 108B, like described above, are configured to be attached to a structure and to secure the unit 2178B to the structure without penetrating the roofing of the structure.

In some embodiments in which the apparatus has two or more units, the apparatus may include only one electrical junction box attached to only one of the flexible mounting substrates and may include only one electrical conduit. For example, in FIG. 21, unit 2178A includes junction box 2130 and flexible electrical conduit 2132. The electrical junction box 2130 and the flexible electrical conduit 2132 are seen electrically connected to the one or more inverters of the two or more units, e.g., inverters 2106A and 2106B of units 2178A and 2178B, respectively, and to the flexible photovoltaic modules of the two or more units, e.g., flexible photovoltaic modules 2104A and 2104B of units 2178A and 2178B, respectively.

The electrical connections of each unit 2178A and 2178B may be similar to described above, including with respect to FIGS. 6, 7, and at least in part 8, such that each unit 2178A and 2178B includes an electrical connector bus 2124A and 2124B, respectively, each inverter of each unit is connected to the electrical connector bus of that unit, e.g., inverters 2106A are electrically connected to electrical connector bus 2124A, such that each electrical connector bus 2124A and 2124B may be connected to the respective flexible mounting substrate 2102A and 2102B. Additionally, each electrical connector bus of the two or more units may be electrically connected to each other; this electrical connection may be made by a jumper cable that electrically connects, and in some embodiments also physically connects, one end of one electrical connector bus to an end of another electrical connector bus of another unit. In FIG. 21, second electrical jumper 2180 is physically and electrically connected to electrical connector bus 2124A and 2124B such that electrical connector bus 2124A is electrically connected to electrical connector bus 2124B. Second electrical jumper 2180 may be connected to one or more of the flexible mounting substrates, e.g., flexible mounting substrate 2102A and/or 2102B. The two units 2178A and 2178B are therefore electrically connected such that the energy generated by the flexible photovoltaic modules 2104A and 2104B of each unit 2178A and 2178B is transported, at least in part, by the flexible electrical conduit 2132 to an external electrical circuit 2134, which may be a power grid. The apparatus of FIG. 21 may also include a termination cable 2121, as mentioned above, which is seen electrically connected to an end of the electrical connector bus 2124B. The termination cable 2121 is configured to seal the exposed connections on the end of the electrical connector bus 2124B when additional units are not to be connected. The termination cable 2121 may include a connector that is both electrically and physically isolated from the outside environment. In some embodiments in which the apparatus includes the cover and the termination cable 2121, the termination cable may be configured to extend through an access hole of the cover when the termination cable is physically and electrically connected to the electrical connector bus.

Additionally, the second electrical jumper 2180 may be configured in a variety of ways. For example, the second electrical jumper 2180 may be a variety of lengths to accommodate the placement of the two units 2178A and 2178B. For instance, units 2178A and 2178B may be on the same roof “plane,” but they may not be in physical contact with each other, but are instead separated by a non-zero distance or offset. In another instance, units 2178A and 2178B may be on different roof planes, such as on opposite sides of a ridge of a roof, or on different roof levels of the structure. In such cases, the second electrical jumper 2180 is of a length that accommodates the distance between the two or more units.

In some embodiments, the two units 2178A and 2178B may be physically connected to each other, such as by hook and loop fasteners (e.g., Velcro™), fasteners, clips, hooks, or other suitable fastener.

Referring back to FIG. 18, the apparatus in FIG. 18 includes two units (not labeled for clarity purposes) like described with respect to FIG. 21. The two units are secured to the house without penetrating the roofing 1858 as described herein above. The flexible electrical conduit 1832 is configured to transport the energy generated by the flexible photovoltaic modules 2104A and 2104B of each unit 2178A and 2178B to the AC disconnect 1840 which is connected to the electric panel of the house 1872, which may be the external electrical circuit 2134.

Additionally, when the apparatus includes more than two units, the apparatus may be configured such as described in FIG. 21 and the more than two units may be configured and electrically connected according to such description so that the energy generated by the flexible photovoltaic modules of all of the more than two units is transported, at least in part, by a single flexible electrical conduit to an external electrical circuit 2134.

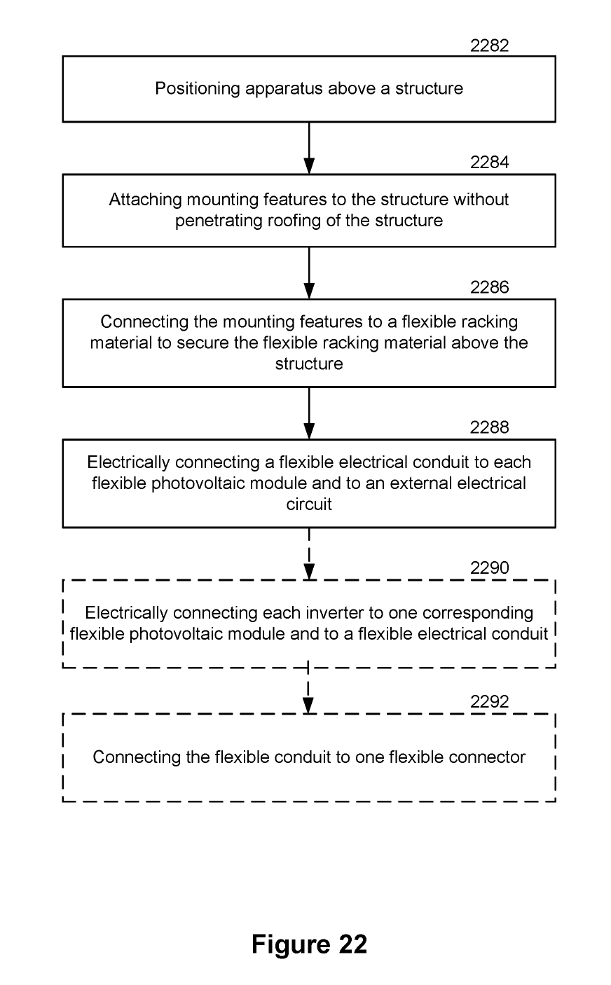

The present disclosure also includes techniques of configuring and/or installing the disclosed apparatuses to a structure. FIG. 22 depicts a flowchart of an example technique. In block 2282, the apparatus is positioned above a structure. This apparatus is an apparatus described herein above and may include a flexible mounting substrate, one or more flexible photovoltaic modules attached to the flexible mounting substrate, and one or more inverters connected to the flexible mounting substrate, and it may also include a unit as described above. The positioning of block 2282 includes positioning the apparatus such that the appropriate surfaces of the flexible photovoltaic modules may be exposed to sunlight. Additionally, this positioning may include placing the flexible mounting substrate directly on, e.g., in direct physical contact with, one or more portions of a roof of a structure. In some such embodiments, a back side of the flexible mounting substrate may be facing roofing of the structure while the top side is facing away from the roofing. Such positioning may also include placing the flexible mounting substrate over the structure but not contacting the roofing such that the flexible mounting substrate is offset from the roofing by a second offset distance.

In block 2284, the plurality of mounting features are attached to the structure without penetrating the roofing of the structure. As discussed above, for instance with regard to FIGS. 11 to 17, the mounting features may be of varying configurations, but these mounting features are nevertheless attached to the structure such that they do not penetrate the roofing of the structure and the waterproofing of the roofing is not modified by such attachment.

In block 2286, each mounting feature is connected to the flexible mounting substrate using the flexible connectors. As stated above, there are a variety of ways in which the flexible connectors may be connected to the flexible mounting substrate and to each mounting feature. In some such embodiments, block 2286 may include physically connecting each flexible connector to the flexible mounting substrate and to each mounting feature. For instance, this may include connecting a first end of each flexible connector to the flexible mounting substrate and connecting a second end of each flexible connector to a corresponding mounting feature. In some other embodiments, the flexible connectors may already be connected to the flexible mounting substrate and block 2286 may only include connecting the flexible connectors to the mounting features. Block 2286 may also include tensioning and/or tightening the flexible connectors such that a secure, tensioned connection is made between the flexible mounting substrate and the mounting features. The connections described in this block may also result in the flexible mounting substrate and/or a unit, being secured above the structure, such as on the roofing of the structure without penetrating the roofing of the structure.

In block 2288, a flexible electrical conduit is electrically connected to each flexible photovoltaic module and to an external electrical circuit, such as a power grid. As discussed above, the flexible electrical conduit may form at least a part of the electrical pathway for the energy generated by the flexible photovoltaic modules of the apparatus to travel to the external electrical circuit. In some embodiments, as stated above, a first end of the flexible electrical conduit may be electrically connected to, e.g., terminated at, the electrical junction box which is electrically connected to the inverters and to the flexible photovoltaic modules of the apparatus thereby electrically connecting the flexible electrical conduit to the flexible photovoltaic modules. Additionally, like described herein, the second end of the flexible electrical conduit may be electrically connected, e.g., terminated, to an AC disconnect, a circuit breaker, or other electrical connection point of an external electrical element which is also electrically connected to the external electrical circuit. For example, the second end of the flexible electrical conduit may terminate at the AC disconnect which is electrically connected to the power grid and in such an example, the flexible electrical conduit is still electrically connected to the power grid, but there are one or more electrical components electrically interposed between the flexible electrical conduit and the electrical grid. In some such embodiments in which the second end of the flexible electrical conduit terminates at the AC disconnect, the technique may also include attaching the AC disconnect to the structure.

Block 2290, which is an optional block that may be performed before or after any other block, includes electrically connecting each inverter to one corresponding flexible photovoltaic module. Referring to FIG. 7, for instance, this may include making the electrical connection between the module connector 116 and the inverter 106 at electrical connection point 122. In some embodiments however, each flexible photovoltaic module may already be connected to a corresponding inverter. Additionally, as discussed above, block 2290 may also include electrically connecting the flexible electrical conduit to the one or more inverters. Such connection may be made by terminating the first end of the flexible electrical conduit directly to the inverter or an electrical connector coupled to the inverter. Such connection may also be made by electrically connecting the inverters to an electrical connector bus, like described above in FIG. 7, that is electrically connected to the electrical junction box and terminating the first end of the flexible electrical conduit to the electrical junction box.

Block 2292, which is another optional block that may be performed before or after any other block, includes connecting a portion of the flexible electrical conduit to one flexible connector. This connecting is described hereinabove with respect to FIGS. 18 and 19 and as stated above, the flexible connector may also be attached to the structure.

It should be noted that the blocks of the techniques disclosed herein may be performed in different orders and that such techniques may also include implementing at least some of the configurations of the apparatus described hereinabove.

In the embodiments described above, the flexible modules are described as being mounted on a flexible mounting substrate, which is described as a substrate capable of being bent to make a U-shape with a radius of approximately the material thickness without causing plastic deformation to the flexible mounting substrate. However, it is also possible that a more rigid, semi-flexible mounting substrate may be used instead of a flexible mounting substrate. For example, the semi-flexible mounting substrate may be capable of being bent up to about 60 degrees, after which plastic deformation occurs to the material. Additionally or alternatively, the semi-flexible mounting substrate may be capable of being bent into a U-shape with a radius of approximately 10 times the material thickness without causing plastic deformation, but the semi-flexible mounting substrate does undergo plastic deformation if bent into a U-shape with a smaller radius.

What is claimed is:

1. An apparatus comprising:
a flexible mounting substrate;
one or more flexible photovoltaic modules, wherein each of the flexible photovoltaic modules is attached to the flexible mounting substrate;
one or more inverters, wherein the one or more inverters are electrically connected to the one or more flexible photovoltaic modules, and wherein each of the inverters is connected to the flexible mounting substrate;
a plurality of mounting features configured to be attached to a structure;
a plurality of flexible connectors, wherein one flexible connecter extends between the flexible mounting substrate and one corresponding mounting feature and wherein each flexible connector is attached to the flexible mounting substrate and attached to a corresponding mounting feature such that the plurality of mounting features is attached to the flexible mounting substrate by the plurality of flexible connectors; and
a flexible electrical conduit, wherein:
a first end of the flexible electrical conduit is electrically connected to the one or more inverters and to the one or more flexible photovoltaic modules,
a portion of the electrical conduit extends along and is attached to one flexible connector, and
each of the mounting features are configured to secure the flexible mounting substrate above the structure without penetrating roofing of the structure.

2. The apparatus of claim 1, wherein:
there are two or more flexible photovoltaic modules,
there are two or more inverters,
each flexible photovoltaic module is electrically connected to one corresponding inverter, and
the two or more inverters are electrically connected in parallel.

3. The apparatus of claim 1, further comprising an electrical junction box that is attached to the flexible mounting substrate, wherein:
the one or more inverters are electrically connected to the electrical junction box, and
the first end of the flexible electrical conduit is electrically connected to the electrical junction box such that the flexible electrical conduit is electrically connected to the one or more inverters at the electrical junction box.

4. The apparatus of claim 1, wherein a second end of the flexible electrical conduit is configured to terminate at an electrical connection point of an external electrical circuit.

5. The apparatus of claim 1, further comprising an alternating current (“AC”) disconnect, wherein a second end of the flexible electrical conduit terminates at the AC disconnect.

6. The apparatus of claim 1, wherein the flexible photovoltaic modules are attached to the flexible mounting substrate by an adhesive.

7. The apparatus of claim 1, further comprising:
a second flexible mounting substrate;
one or more second flexible photovoltaic modules, wherein each of the second flexible photovoltaic modules is attached to the second flexible mounting substrate;
one or more second inverters, wherein the one or more second inverters are electrically connected to the one or more second flexible photovoltaic modules, and wherein each of the second inverters is attached to the second flexible mounting substrate;
a plurality of second mounting features configured to be attached to the structure; and
a plurality of second flexible connectors, wherein one second flexible connecter extends between the second flexible mounting substrate and one corresponding second mounting feature and wherein each second flexible connector is attached to the second flexible mounting substrate and attached to a corresponding second mounting feature such that the plurality of second mounting features is attached to the second flexible mounting substrate by the plurality of second flexible connectors, wherein:
the one or more second inverters are electrically connected to the one or more inverters and electrically connected to the first end of the flexible electrical conduit, and
each of the second mounting features are configured to secure the second flexible mounting substrate above the structure without penetrating the roofing of the structure.

8. The apparatus of claim 1, wherein each flexible photovoltaic module has a power-to-weight performance ratio greater than about 55 Watts per kilogram.

9. The apparatus of claim 1, wherein each flexible photovoltaic module has a photovoltaic stack with a thickness of about 2 microns or less that is positioned on a substrate with a thickness of about 50 microns or less.

10. The apparatus of claim 1, wherein the flexible mounting substrate is comprised of high-density polyethylene.

11. The apparatus of claim 1, further comprising a cover that is attached to the flexible mounting substrate and that covers the one or more inverters such that the one or more inverters are interposed and at least partially enclosed by the flexible mounting substrate and the cover.

12. The apparatus of claim 1, further comprising one or more inverter frames attached to the flexible mounting substrate, wherein each inverter is attached to one corresponding inverter frame such that each inverter is not in direct contact with the flexible mounting substrate and is offset from the mounting substrate by a first offset distance.

13. The apparatus of claim 1, further comprising a ridge protector, wherein the ridge protector is configured to be positioned on a ridge of the roof and interposed between a flexible connector and the ridge of the roof such that there is no contact between the ridge and the flexible connector.

14. A method comprising:
positioning an apparatus above a structure, wherein the apparatus includes a flexible mounting substrate, one or more flexible photovoltaic modules attached to the flexible mounting substrate, and one or more inverters attached to the flexible mounting substrate;
attaching a plurality of mounting features to the structure without penetrating a roofing of the structure;
connecting, using a plurality of flexible connectors, each mounting feature to the flexible mounting substrate such that the flexible mounting substrate is secured above the structure, wherein one flexible connecter extends between the flexible mounting substrate and one corresponding mounting feature; and
electrically connecting, using a flexible electrical conduit, the one or more flexible photovoltaic modules to an electrical connection point of an external electrical circuit.

15. The method of claim 14, further comprising:
electrically connecting each inverter to one corresponding flexible photovoltaic module, and
electrically connecting the flexible electrical conduit to the one or more inverters.

16. The method of claim 14, further comprising electrically connecting each inverter to an electrical junction box, wherein:
each inverter is electrically connected to one corresponding photovoltaic module, and
electrically connecting the one or more flexible photovoltaic modules to the electrical connection point of the external electrical circuit further comprises electrically connecting a first end of the flexible electrical conduit to the junction box and electrically connecting a second end of the flexible electrical conduit to the electrical connection point of the external electrical circuit.

17. The method of claim 16, wherein electrically connecting the one or more flexible photovoltaic modules to the electrical connection point of the external electrical circuit further comprises electrically connecting the second end of the flexible electrical conduit to an alternating current (“AC”) disconnect that is electrically connected to the external electrical circuit.

18. The method of claim 14, further comprising attaching the AC disconnect to the structure.

19. The method of claim 14, wherein connecting each mounting feature to the flexible mounting substrate further comprises connecting a first end of each flexible connector to the flexible mounting substrate and a second end of each flexible connector to a corresponding mounting feature.

20. The method of claim 14, further comprising connecting a portion of the flexible electrical conduit to one flexible connector.
